(19) United States
(12) Patent Application Publication
(10) Pub. No.: US 2011/0253261 A1
(43) Pub. Date: Oct. 20, 2011

(54) Automatic Workpiece Edging and Ripping Device and Method

(76) Inventor: Ronald W. McGehee, Ukiah, CA (US)

(21) Appl. No.: 13/080,545

(22) Filed: Apr. 5, 2011

Related U.S. Application Data
(60) Provisional application No. 61/324,668, filed on Apr. 15, 2010.

(51) Int. Cl. B27B 5/18; B27B 5/29; B27B 1/00

(52) U.S. Cl. 144/376; 144/2.1; 144/286.5

(57) ABSTRACT

A sawing apparatus for a wood products sawing system comprises a frame, a sawing table, a workpiece clamping element, and an overhead saw assembly. A workpiece can be supported on the sawing table and releasably secured to the table by the workpiece clamping element. The overhead saw array is supported by the frame and includes a saw driver and a row of at least three saw assemblies so to sever the workpiece along the cut line by movement of the saw blades along two dimensional paths. A variable width sawing table comprises a driving assembly and a row of support arm assemblies mounted to the frame member and coupled to the driving assembly for movement to at least first and second positions.

### BACKGROUND OF THE INVENTION

1. Field of the Invention

The present invention relates generally to sawmill equipment, and more particularly to an apparatus and method finding particular utility for ripsawing a workpiece to remove the waste wane edges therefrom and expose an optimum usable board area.

2. Description of the Prior Art

In sawmill operations, an incoming log is typically cut along a number of parallel, axial planes to yield a number of irregularly shaped planks referred to as side boards or workpieces. The length of the workpiece is determined by the length of the log from which it was cut and is the same for all workpieces cut from the same log. The width of each workpiece, however, will vary depending on the particular section of the log which was cut. Workpieces which are derived from the central core of the log will be much wider than those derived from the edge of the log. Moreover, the workpieces will generally taper in one direction corresponding to the lessening diameter of the tree towards its top.

A workpiece will generally have two parallel, cut faces resulting from the initial ripsawing of the log, as well as a pair of irregular edges corresponding to the outer perimeter of the log. These rounded or beveled edges are referred to as waste wane edges and are usually removed before cutting the workpiece into boards.

An important concern in operating a sawmill is optimizing the recovery of finished boards from any given log. Normally this will mean maximizing the total board feet of lumber derived from each log, although it may mean recovering a maximum number of boards of a certain length or having some other characteristic which makes them particularly valuable.

U.S. Pat. No. 4,086,496 describes a machine for optimally sawing workpieces which comprises a first conveyor for transporting the workpiece transversely beneath an optical scanning system. The workpieces are fed to a second conveying system which delivers them axially beneath a pair of rotary saw blades. The distance between the saw blades may be adjusted in response to the profile determined by the optical scanning means, and the workpiece is initially oriented to pass through the saw blades at the optimal orientation. Although generally functional, it is very difficult to maintain the proper orientation of the workpiece as it is advanced beneath the saw blades. Thus, the workpiece is able to fall out of alignment and the resulting sawn edges are neither optimum nor straight.

Other devices for optimally trimming the wane edges from workpieces are disclosed in U.S. Pat. Nos. 3,970,128; 3,963,938; 3,983,403; and 3,890,509. A device for removing a single waste wane edge from a workpiece prior to ripcutting is disclosed in U.S. Pat. No. 4,196,648.

U.S. Pat. Nos. 4,468,992 and 4,676,130 disclose devices for removing the waste wane edges and ripcutting a workpiece by clamping the workpiece to a sawing table and moving a plurality of saws, traveling on tracks, over the workpiece simultaneously removing the waste wane edges and ripcutting the workpiece into boards.

The major drawback to all of the systems known in the prior art is the slow processing speed and the limited production of cut boards. As typified by the device of U.S. Pat. No. 4,086,496, automatic sawing systems of the prior art have required that after initial orientation, the workpiece be translated axially under one or more stationary saws. While such an approach would seem to allow optimum cutting, in fact it is extremely difficult to maintain the alignment of the workpiece while it is being advanced beneath the saws. The need to advance the workpiece inhibits the ability to firmly hold the workpiece in the preselected orientation. The total time required to process each workpiece is dependent upon how much time it takes to advance the workpiece through the saws (the sawing time) and how much time it takes to get the next workpiece optimally positioned and started advancing toward the saws the (gap time between workpieces). The sawing time for a given workpiece is dependent upon the length of the workpiece and the rate at which it is advanced through the saws. Typical state of the art advance rates for workpieces range between fifteen and twenty feet per second. Therefore, the sawing time for a 20 foot (6 m) long board typically ranges between 1.00 and 1.25 seconds with conventional equipment while the sawing time for a 10 (3 m) foot long board is half that for 20 foot (6 m) long board. Typical gap times, between workpieces, range between 0.6 and 1 second, with the average being approximately 0.75 seconds.

One approach to solve the problem of maintaining optimal workpiece alignment is disclosed in U.S. Pat. No. 4,281,696, where after optical scanning, a first edge of the workpiece is removed by an overhead saw. Thereafter, the workpiece is advanced beneath conventional overhead saws with the pre-sawn edge held against a fixed boundary wall. It this way, the alignment of the workpiece beneath the saws is improved, although after sawing the leading wane edge off, the internal stress release can cause the sawn leading edge to buckle resulting in misalignment. The device, moreover, requires two separate sawing operations which increase both its capital cost and operating cost. The production of this device is limited just the same as other prior art devices because each workpiece must be advanced through the saws.

Another approach to solve the problem of maintaining optimal workpiece alignment is disclosed in U.S. Pat. No. 4,468,992. This device overcomes the alignment problem by holding the workpiece stationary beneath movable saw blades A clamping mechanism is provided which engages the workpiece firmly along its central axis, holding the workpiece substantially immovable on a stationary sawing table. The desired cuts are then performed by two or more overhead saws which travel along a fixed path transverse to the forward path of the apparatus. The waste wane edges fall away and the sawn boards are transferred to an outfeed conveyor. While this device does substantially eliminate the workpiece misalignment problems found in other systems, it does have the same production limitations as those systems. The maximum production of workpieces is limited by the length of each individual workpiece.

### BRIEF SUMMARY OF THE INVENTION

The present invention is directed at a method and system for ripcutting workpieces simultaneously along parallel lines in such a manner that, maximum production and optimum value recovery from each workpiece is attained. The system directs the workpieces along a substantially straight path with several work stations located along the path. The workpiece is first sent through a scanning or workpiece interrogation station where the workpiece is optically assessed. The information collected at the scanning station is feed into the control system where the optimum sawing solution is computed. The workpiece continues traveling to the workpiece positioning station where the workpiece gets transferred and properly aligned according to the computed optimum sawing solution on a movable sawing table located at the workpiece sawing station. After the workpiece has been aligned at the sawing station according to the computed sawing solution, workpiece clamping devices engage and firmly hold stationary the workpiece to the sawing table while a plurality of overhead saw blades, typically arranged in two parallel rows, move down and through the workpiece cutting along optimal sawing lines as determined by the scanning station and control system. This typically results in removing the waste wane edges resulting in a substantially rectangular board. Additionally, if it is desirable to further saw the workpiece into additional pieces, the plurality of overhead saw blades will realign over the workpiece and move back down and through the workpiece further cutting the workpiece into smaller boards. The resulting waste wane edges drop away into a waste transfer system and the sawn boards are transferred away from the sawing system for further processing.

The present invention is an improvement over the prior art, as it not only allows for the accurate alignment and cutting of the workpieces, it can also substantially reduce the sawing time required to cut the workpiece resulting in substantially higher production of sawn boards.

The present invention overcomes the problem of workpiece production being limited by the length of each individual workpiece. The sawing time of the present invention is not related to or dependent upon the length of any given workpiece. The sawing time of the present invention is essentially fixed. The time it takes to saw the workpiece is dependent upon the time it takes to move the overhead saws down and through the workpiece along two-dimensional paths. The sawing time has been determined through testing to be approximately 0.3 seconds for an example using a circular saw blade path and approximately 0.5 seconds for an example using a rectilinear saw blade path. Such a device, which saws the workpiece with a plurality of overhead saw blades aligned in rows and movable along two-dimensional saw blade paths, is unknown in the prior art. This results in a sawing time that is usually substantially less than achieved with conventional systems, that is about 1.00 to 1.25 seconds for a 20 foot (6 m) board and about 0.5 to 0.625 seconds for a 10 foot (3 m) board.

An example of a sawing apparatus, usable as part of a wood products sawing system, comprises a frame, a sawing table, a workpiece clamping element, and an overhead saw assembly. A workpiece can be supported on the sawing table. The sawing table has a table length axis and the workpiece has a workpiece length and a cut line generally parallel to the table length axis. The workpiece clamping element is supported by the frame and is arranged over the sawing table. The workpiece clamping element is placeable in a clamp position, to secure the workpiece against the sawing table with the cut line oriented parallel to the table length axis, and a release position, to release the workpiece from the sawing table. The overhead saw array is supported by the frame and includes a saw driver and a row of at least three saw assemblies. Each saw assembly comprises a saw blade rotatable around a saw rotation axis passing through the center of the saw blade. The saw rotation axes are parallel to one another. The overhead saw array also include saw drive mechanism, rotatably connecting the saw driver to the saw blades so to drive the saw blades around their saw rotation axes, and means for simultaneously moving the saw blades along two-dimensional paths. The two-dimensional paths are aligned and define a plane oriented perpendicular to the saw rotation axes. The workpiece can be severed along the cut line by movement of the saw blades along the paths. Some examples include a plurality of parallel rows of the saw assemblies. In some examples, the saw driver comprises a plurality of saw drive motors, each saw drive motor comprising an output shaft; in some examples, the saw drive mechanism comprises said output shaft of the saw drive motor with the saw blade being driven directly by the output shaft. In some examples, the sawing table comprises a variable width workpiece support surface.

An example of a method for sawing a workpiece along a cut line is carried out as follows. A workpiece is temporarily secured on a sawing table with a cut line oriented at a desired orientation. A row of at least three saw assemblies is positioned over the workpiece. Each saw assembly comprises a saw blade rotatable around a saw rotation axis passing through the center of the saw blade with the saw rotation axes being parallel to one another. The saw blades are rotated around their saw rotation axes. The workpiece is severed along the cut line by moving the rotating saw blades along two-dimensional paths passing through the cut line, the paths being aligned and defining a plane oriented perpendicular to the saw rotation axes. The severed workpiece is released from the sawing table. In some examples, a plurality of parallel rows of said saw assemblies are positioned over the workpiece. In some examples, each saw blade is rotated by a separate saw drive motor. In some examples, the saw blades rotating step comprises drivingly coupling the output shaft of a saw drive motor to an associated saw blade through a drivetrain comprising at least one pulley and at least one drive belt, the output shaft being laterally offset from the associated saw rotation axis. In some examples, the workpiece severing step comprises moving the saw blade along a curved path so that the two-dimensional path is a curved two-dimensional path. In some examples, the workpiece severing step comprises moving the saw blade along a path comprising at least one straight segment so that the two-dimensional path is a path comprising at least one straight segment.

An example of a sawing table, usable as part of a wood products sawing apparatus, comprises a frame member and a table assembly. The frame member has a length. The table assembly comprises a driving assembly and a row of support arm assemblies mounted to the frame member and coupled to the driving assembly for movement to at least first and second positions. Each support arm assembly comprises a support arm positioned above the frame member. The support arms have upper surfaces defining a support table surface. The support table surface has a width oriented perpendicular to the length of the frame member. The width of the support table is shorter when the support arm assemblies are in the first position than in the second position. In some examples, the support arms define gaps therebetween when in the first and second positions.

Other features, aspects and advantages of the present invention can be seen on review the figures, the detailed description, and the claims which follow.

### BRIEF DESCRIPTION OF THE DRAWINGS

FIG. 1 is an isometric view of the infeed side of a first example of a sawing system of the present invention illustrating workpieces being fed into the system.

FIG. 2 is an isometric view of the outfeed side of the sawing system of FIG. 1 illustrating sawn boards being taken away from the system.

FIG. 3 is a top view of the sawing system of FIG. 1.

FIG. 4 is an isometric sectional view through section line 4-4 of FIG. 3

FIG. 4A is a view similar to that of FIG. 4 primarily illustrating the overhead saw array, workpiece positioner and adjustable width sawing table.

FIG. 5 is an end view illustrating the workpiece being positioned on the adjustable width sawing table.

FIGS. 5A-5G are simplified, enlarged side views similar to that of FIG. 5 illustrating the operational sequence of the overhead saw array and the workpiece positioner, in conjunction with the adjustable width sawing table, illustrating edging of a rough workpiece, ejection of the resulting cut board, and placing a new rough workpiece onto the adjustable width sawing table in preparation for repeating the procedure.

FIG. 5H is a partial perspective view illustrating some of the structure of FIG. 5G, but showing only one workpiece clamping device.

FIG. 6 is an end view similar to that of FIG. 5 with the horizontal carriage moved to the right.

FIG. 7 is an isometric view of one array of saws poised over the optimum sawing or cut line.

FIG. 8 is an isometric view of one array of saws swinging through the workpiece along the optimum sawing line.

FIG. 9 illustrates two saws in the array along with the swing radii of each saw just prior to beginning to saw through the workpiece similar to FIG. 7.

FIG. 10 illustrates two saws in the array midway along the swing through the workpiece, similar to FIG. 8.

FIG. 11 illustrates two saws in the array positioned at the end of the swing of FIG. 10 ready to swing back down and through the workpiece.

FIG. 12 is an end view illustrating the board positioner discharging a cut board and positioning a new workpiece.

FIG. 13 illustrates one swing saw assembly with drive shaft.

FIG. 13A is a cross-sectional view taken through the structure of FIG. 13 with portions removed for clarity of illustration

FIGS. 14-14B are isometric views of the adjustable width sawing table with the support arms at intermediate, narrow and wide support width positions.

FIG. 15 is a top, right side, front isometric view of the adjustable sawing table of FIGS. 14-14B illustrating a workpiece positioned on the sawing table.

FIG. 15A is a bottom, left side, front isometric view of the structure of FIG. 15.

FIG. 16 is an isometric view of a workpiece positioner illustrating its axes of motion.

FIG. 17 is an isometric view illustrating a second example of an overhead saw array.

FIGS. 18-21 are a series of figures illustrating the sequence of movements for the cutting cycle of the overhead saw array of FIG. 17.

FIGS. 22-27 show a third example of a sawing system similar to the swing saw type of sawing system of FIGS. 1-16.

FIG. 22 is an isometric view of the infeed side of the third example of the sawing system.

FIG. 23 is an isometric view of the outfeed side of the sawing system of FIG. 22.

FIG. 24 is an isometric view of the overhead saw array of FIGS. 22 and 23 including a row of swing saw assemblies each moved along a two-dimensional path by a common swing saw actuator.

FIGS. 25 and 26 are enlarged isometric views showing one of the swing saw assemblies of FIG. 24.

FIG. 27 is a cross-sectional view of the swing saw assembly of FIG. 25.

### DETAILED DESCRIPTION OF THE PREFERRED EMBODIMENTS

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

The automatic workpiece edging and ripping system associated with the present invention includes four major sub-systems. First, a conveyor sub-system is provided for advancing workpieces along a substantially straight path in a generally transverse direction relative to their elongated axis. The conveyor sub-system includes mechanisms for adjusting the alignment of the workpiece and for supporting the workpiece in a fixed orientation on an adjustable width sawing table beneath overhead saw blades, as will be discussed in detail hereinafter. The second major sub-system is the optical detector or workpiece interrogator which scans the workpiece as it is advanced and determines the orientation which provides for an optimum cut. The third sub-system is an overhead sawing array which is capable of cutting along at least one and preferably at least two predetermined parallel lines while the workpiece is held stationary on the sawing table by the workpiece clamping device. Finally, the fourth subsystem is a control system, typically a microcomputer or programmable digital controller, provided to oversee the operation of the mechanical systems and to determine the location of the optimal cutting lines. The second and fourth subsystems can be generally conventional.

One aspect of the invention relates to a sawing apparatus, including a row of saw assemblies movable along two dimensional saw blade paths, usable as parts of a wood products sawing system. Another aspect of the invention relates to a sawing table defining a variable width table support surface, usable as part of a wood products sawing apparatus. Associated methods are also disclosed.

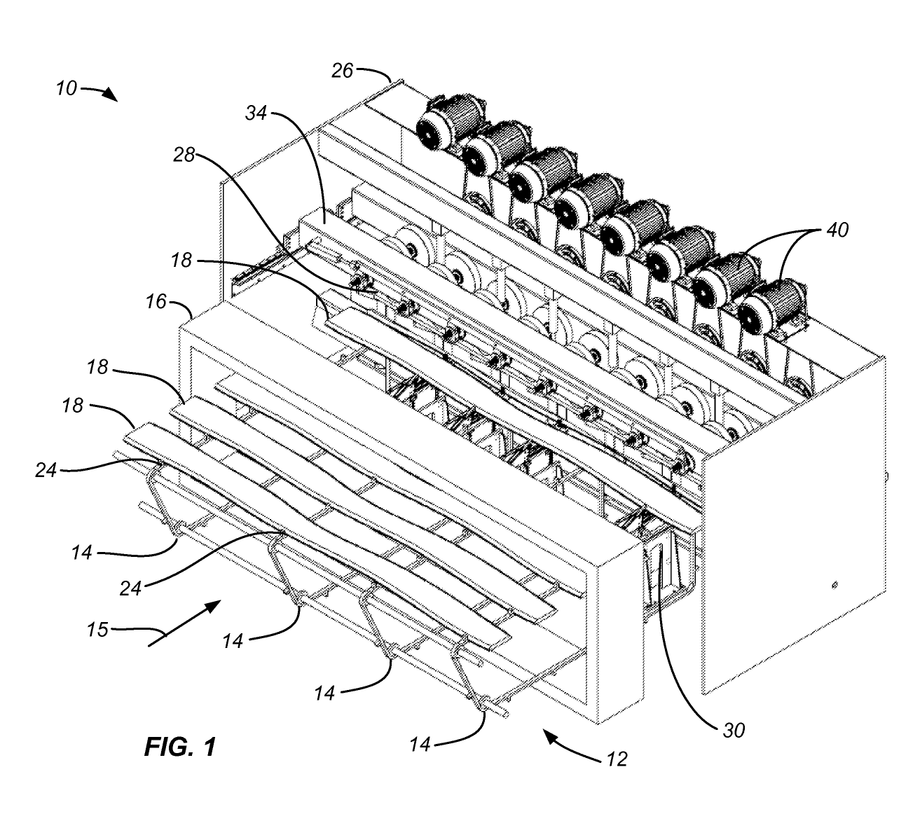

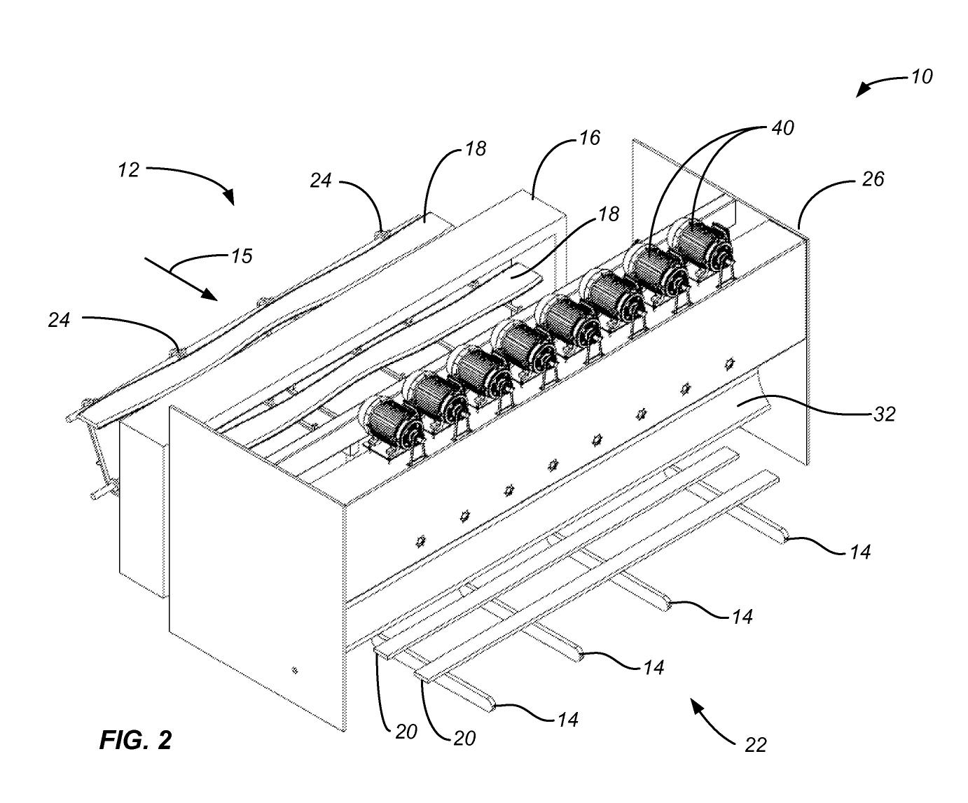

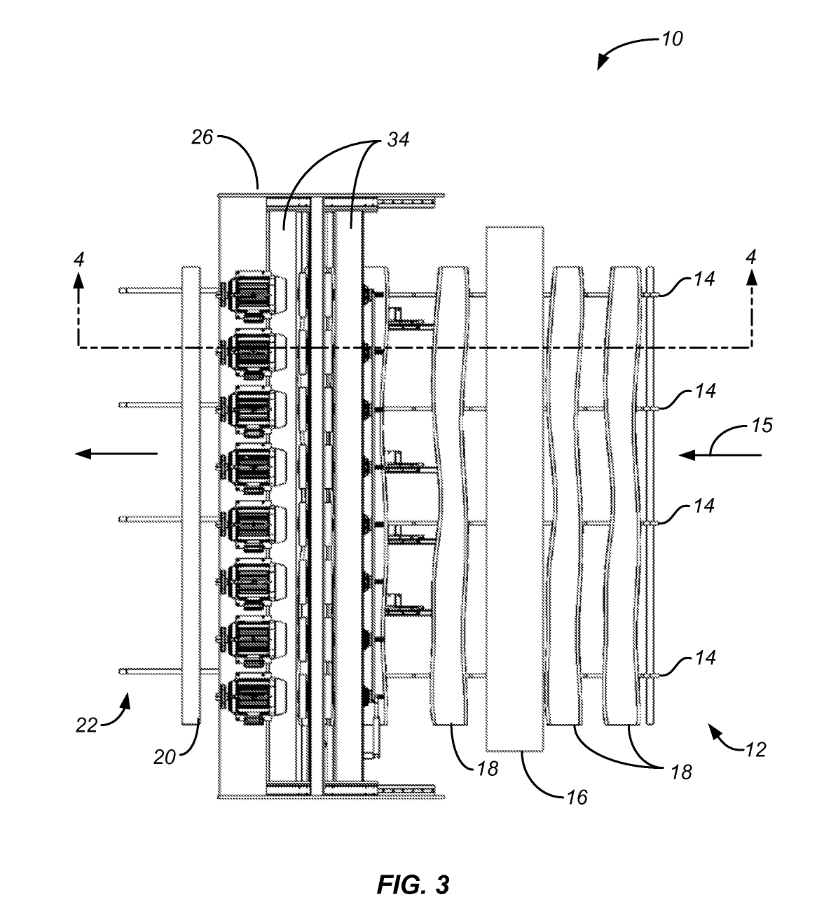

Referring to FIGS. 1, 2, 3 and 3A, overall views of the sub-systems of one example of an automatic workpiece edging and ripping system 10 constructed according to the principles of the present invention are provided. The conveyor sub-system of the sawing system 10 includes an infeed conveyor 12, a plurality of workpiece positioners 30, an adjustable width sawing table 28, a diverter tipple 32 and an outfeed conveyor 22. Both infeed conveyor 12 and outfeed conveyor 22 are conventional chain conveyors comprising a plurality of individual chains 14. The individual chains 14 of the infeed conveyor 12 include advancing lugs 24. In each case, the chains 14 are synchronously driven so that the advancing lugs 24 remain transversely aligned and workpieces 18 are advanced in a direction substantially normal to their elongated axis. The various components of the conveyor sub-system, as well as other sub-systems, are mounted on a frame 26 a portion of which is shown in FIGS. 1, 2 and 3. The control sub-system is typically included in a central control apparatus. Examples of control subsystems are sold by MPM Engineering Ltd., Surrey, British Columbia, Canada and Nelson Bros Engineering, Trout Lake, Wash., USA.

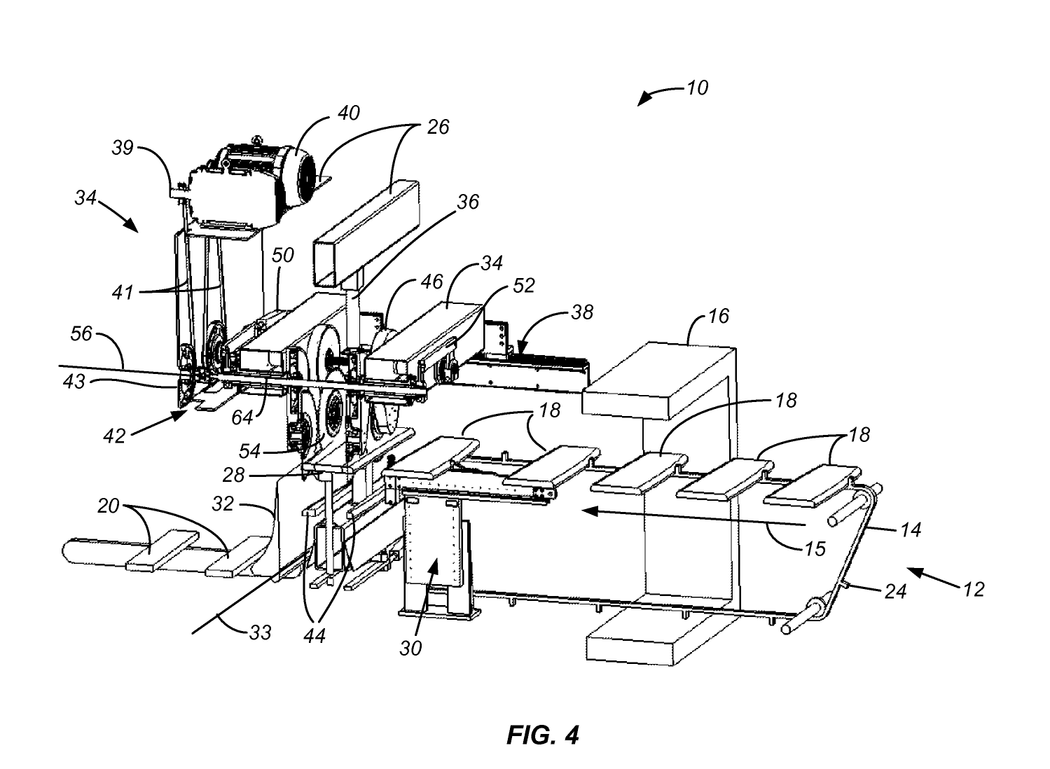

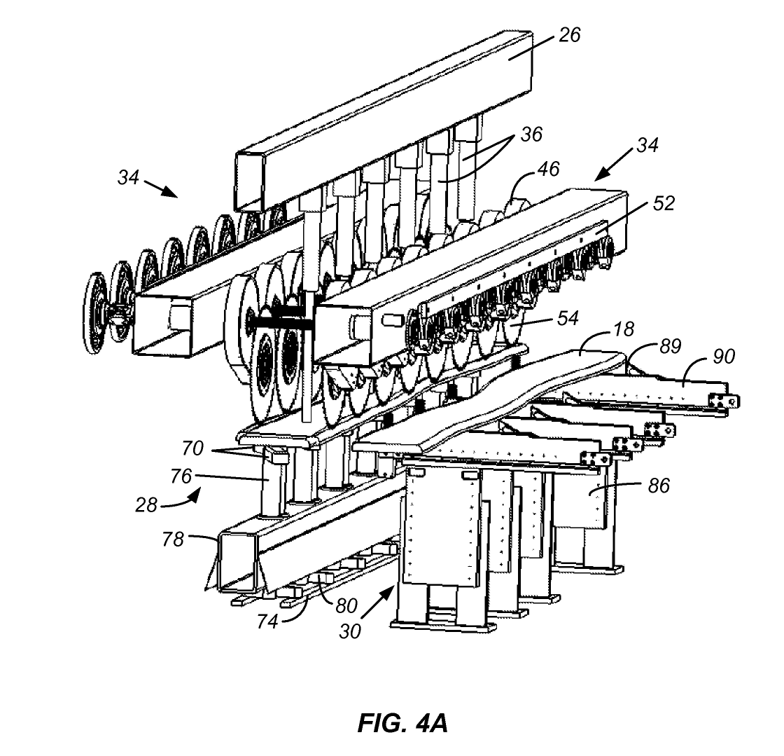

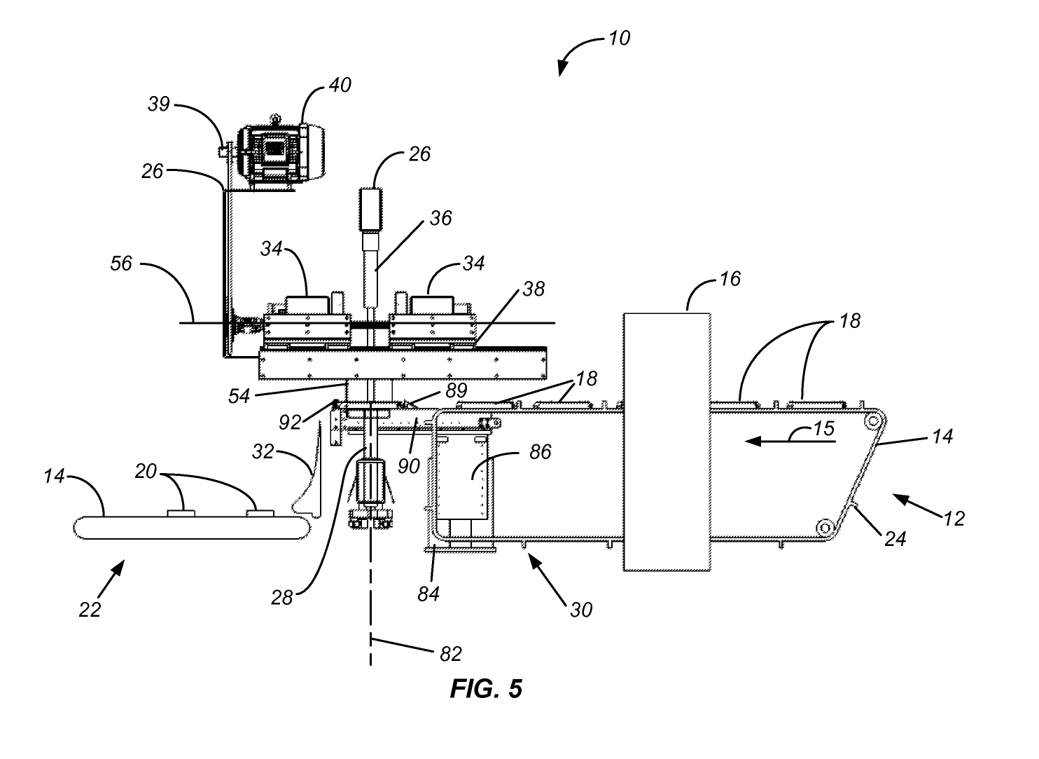

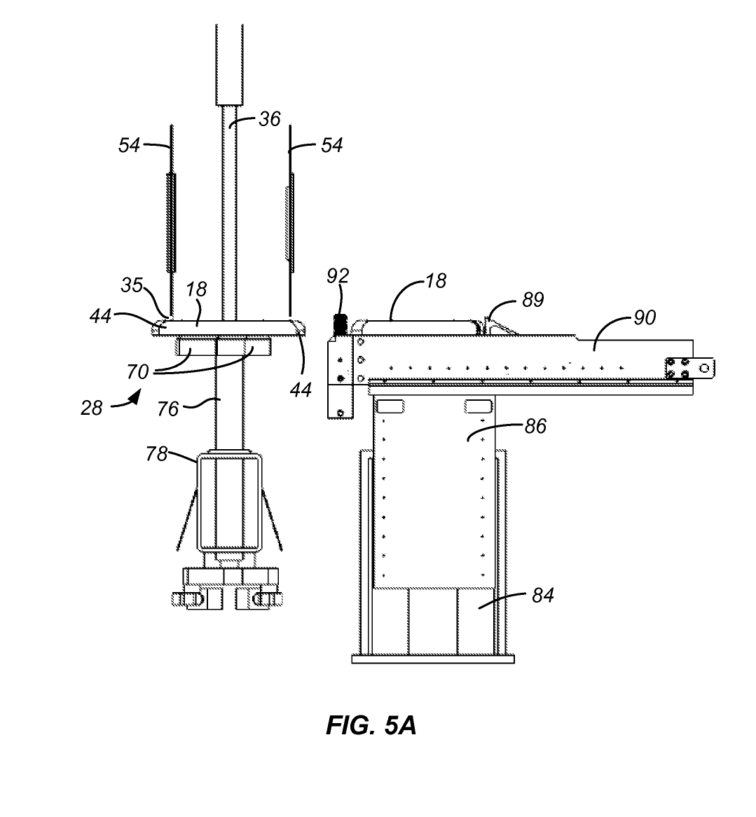

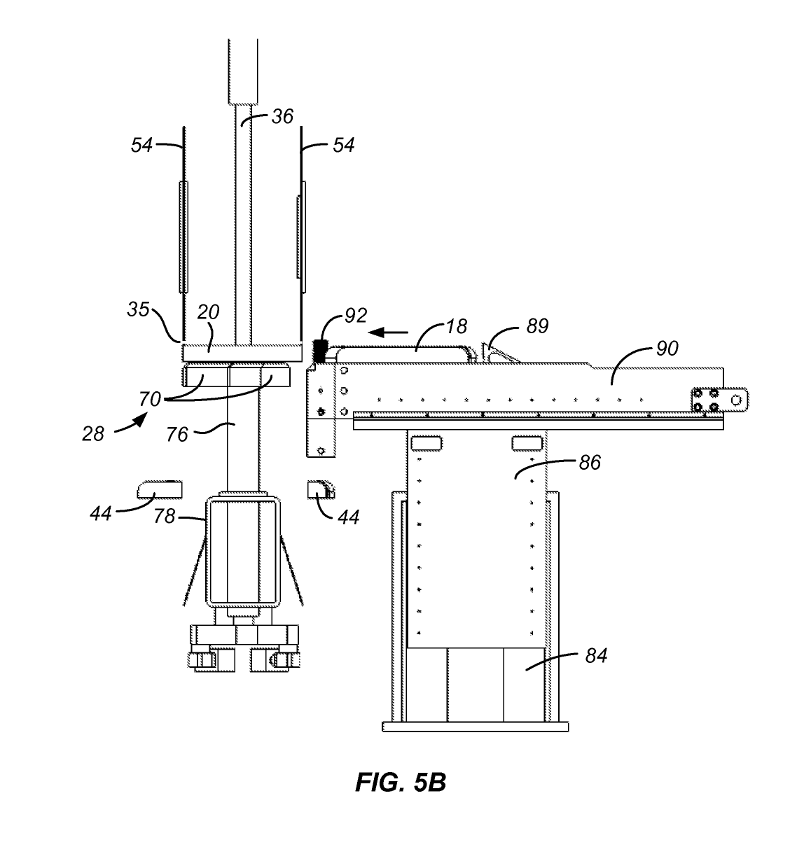

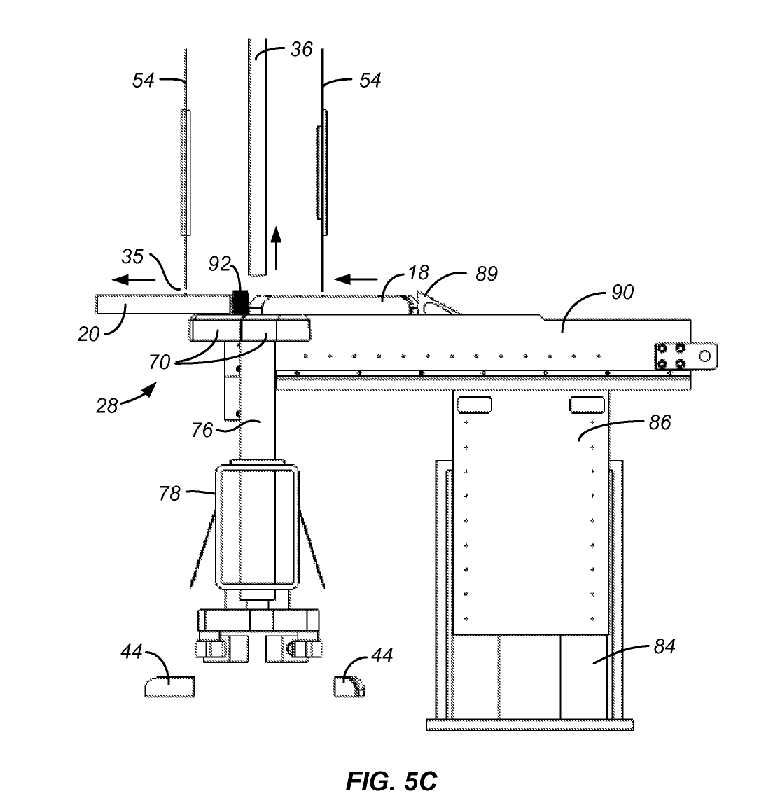

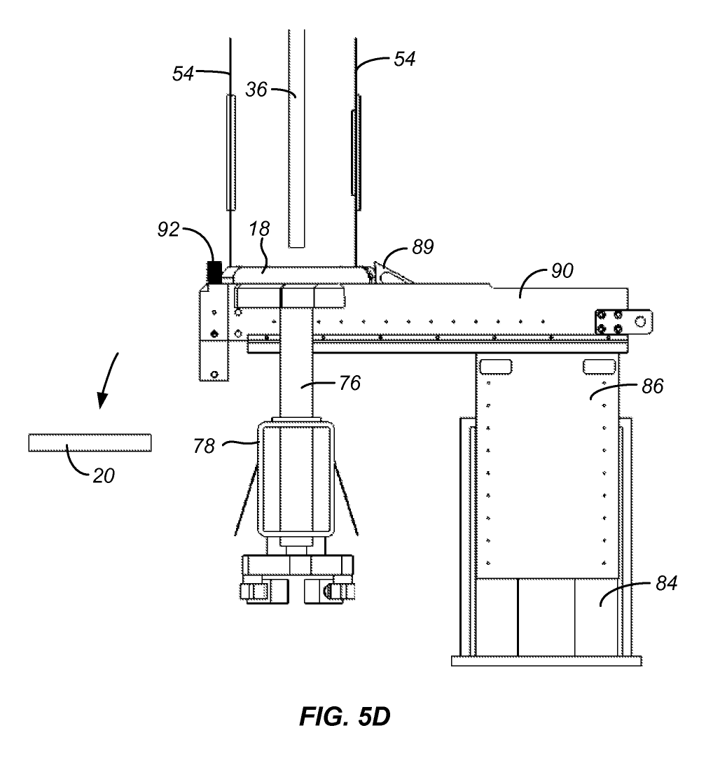

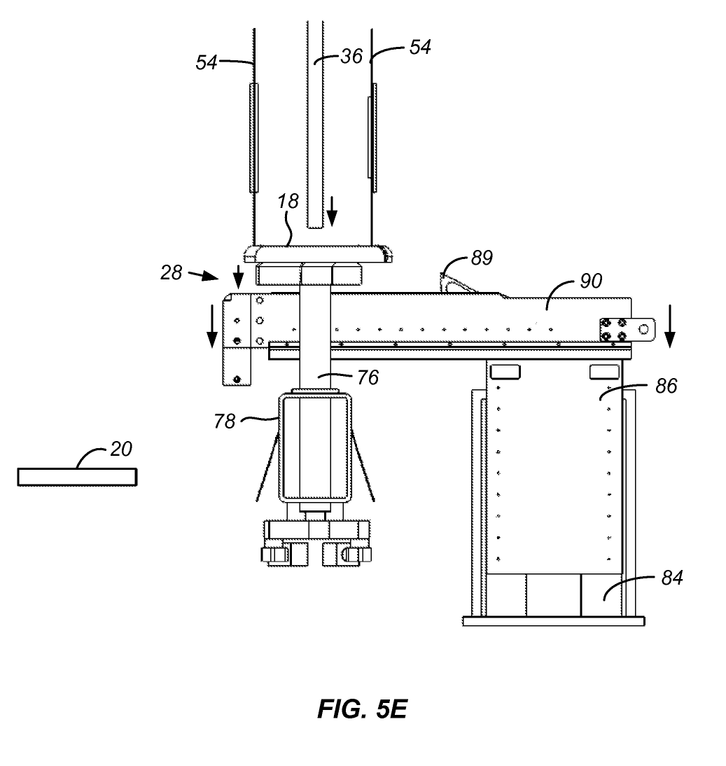

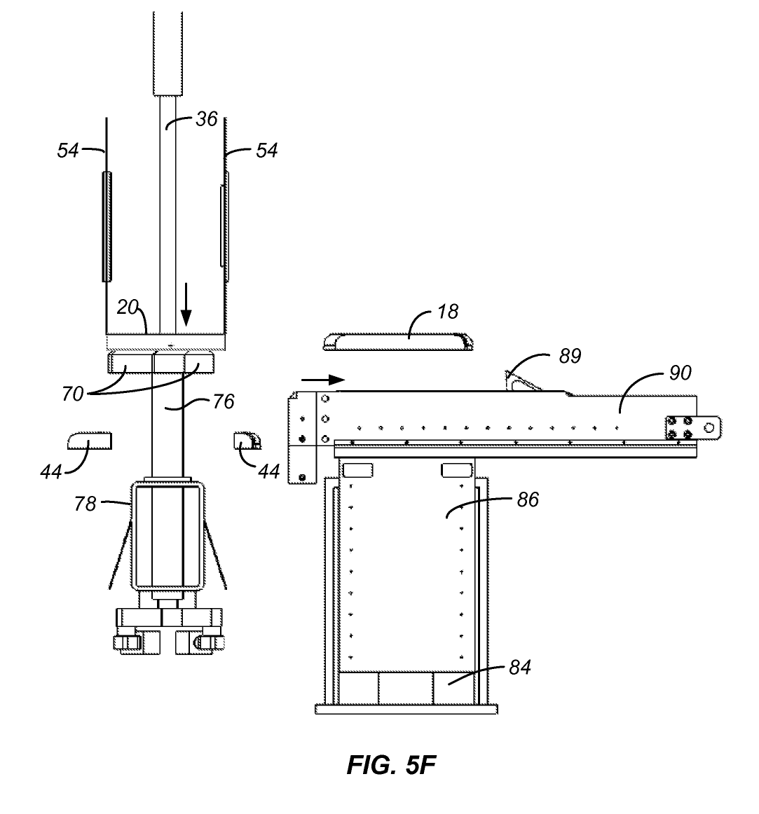

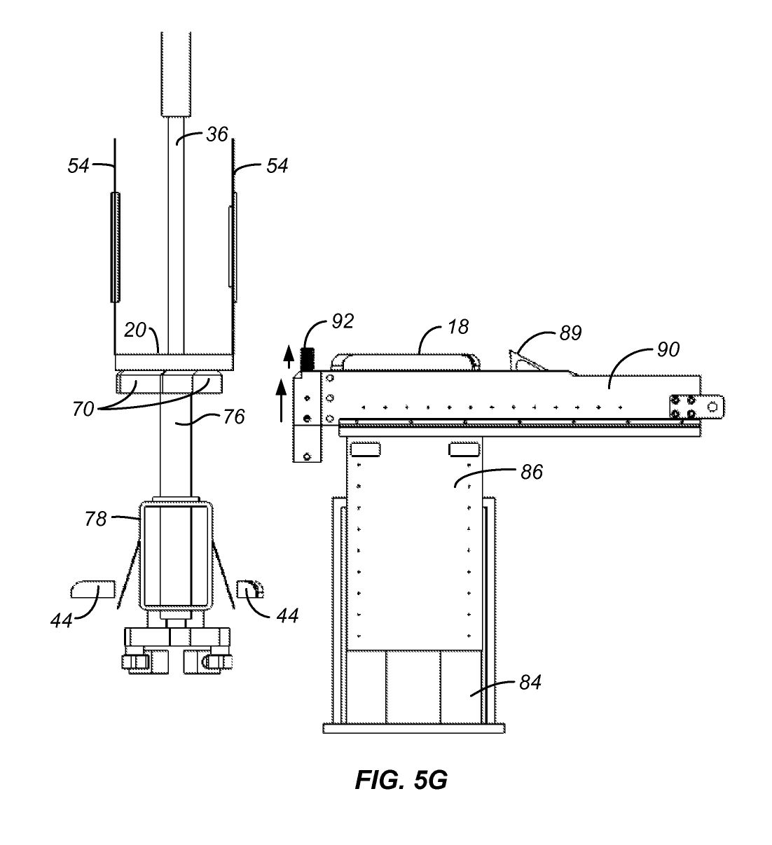

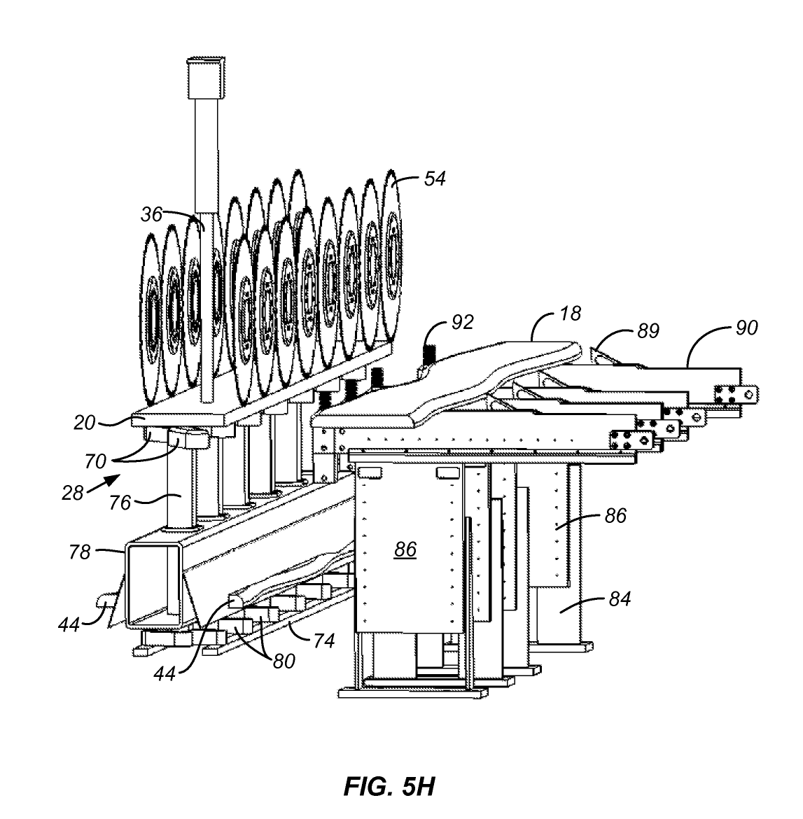

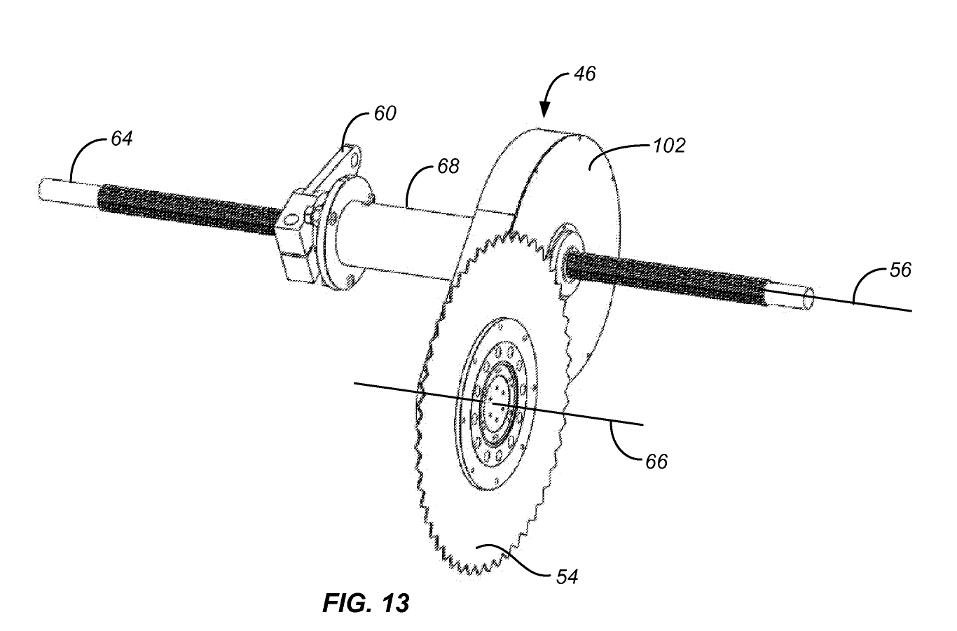

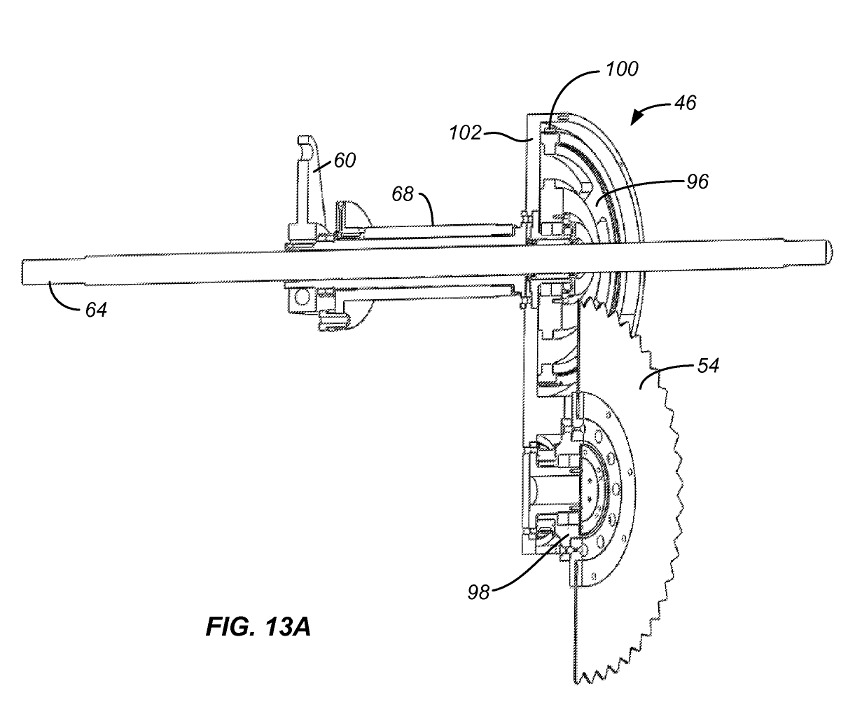

Referring to FIGS. 4, 4A, 5-5H and 6, the infeed conveyor 12 comprising chains advancement lugs 24 engage the workpieces 18 advancing workpieces 18 along feed path 15 through optical workpiece interrogator 16 where data associated with the physical properties of the workpieces 18 are collected and transferred to the control system for processing. The workpieces 18 continue advancement along feed path 15 and are deposited at the workpiece positioner station 30 as shown in FIGS. 5A-5G. Each overhead saw array 34 is supported on and positionable along saw array slide ways 38 as seen in FIGS. 4 and 5. Each saw blade 54 is typically driven by a saw drive motor 40 and by a saw drive mechanism 42. Saw drive mechanism 42 includes a belt 41 coupling the output shaft 39 of saw drive motor 40 to a driven pulley 43, the driven pulley being keyed to a saw drive shaft 64. The remainder of saw drive mechanism 42, which connects saw drive shaft 64 to saw blade 54, is discussed below with reference to FIGS. 13 and 13A. Other conventional or unconventional structures for rotating saw blades 54 about their axes, consistent with the movement of saw blades 54 along two-dimensional paths, can also be used. It is presently preferred to use a separate saw drive motors 40 for each saw blade 54. However, in some cases it may be desirable to drive more than one saw blade 54 with a single saw drive motor 44 other type of saw driver.

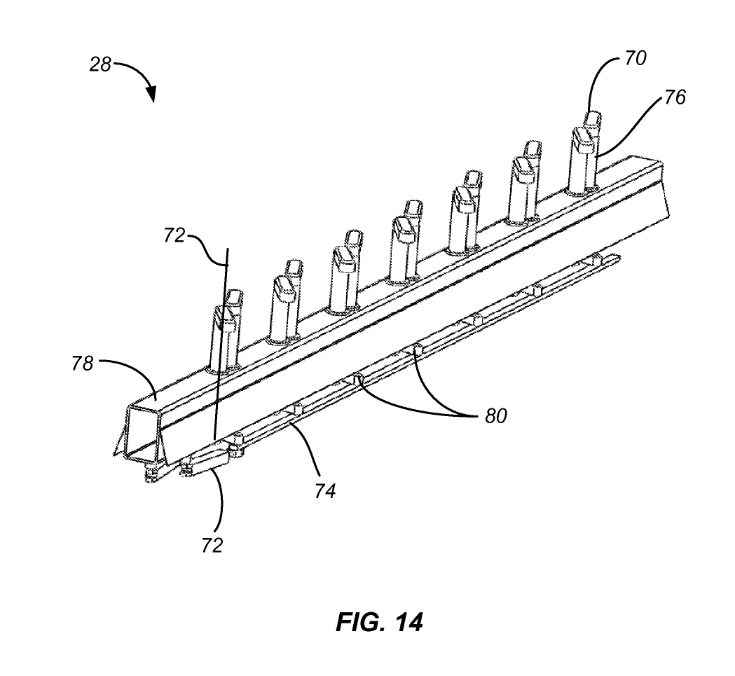

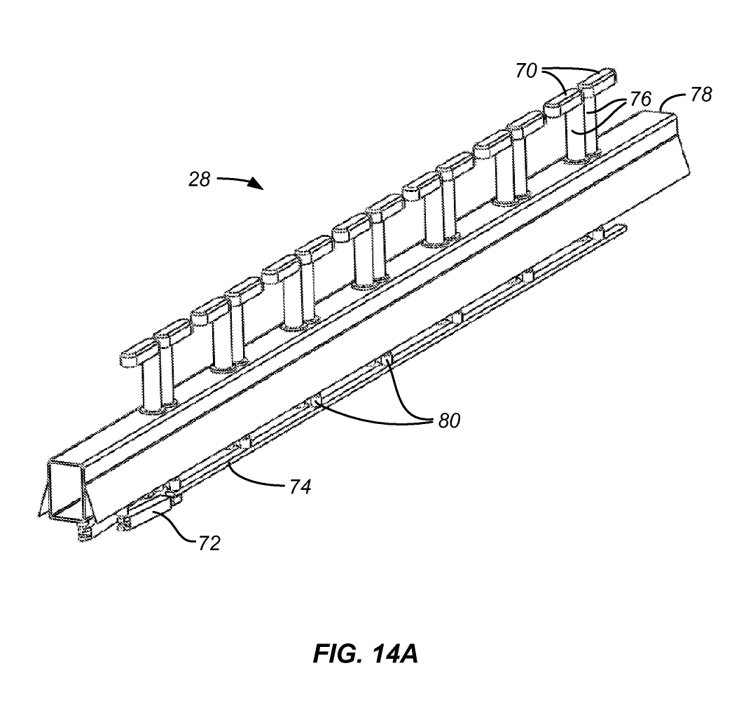

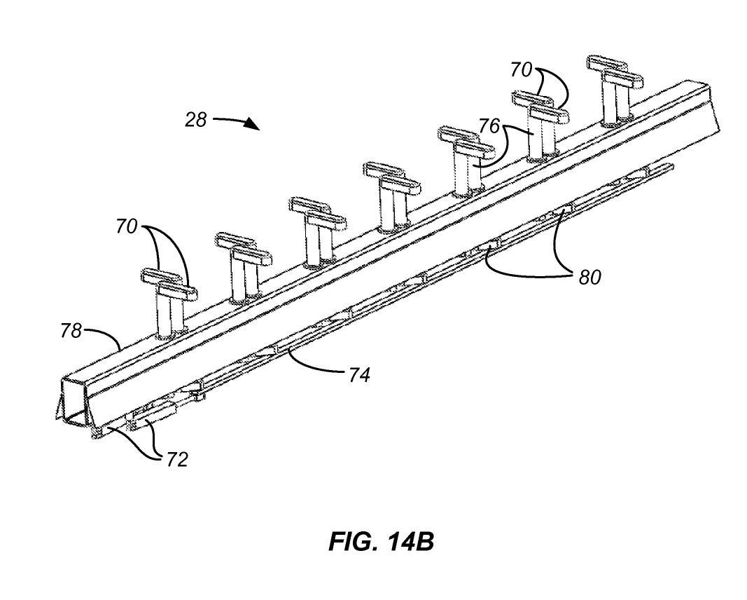

FIG. 5A shows a workpiece 18 secured to adjustable width sawing table 28 by the six workpiece clamping devices 36 just prior to saw blades 54 being actuated to cut off waste wane edges 44. Saw table 28 has a table length axis and the workpiece 18 has a workpiece length generally parallel to the table length axis. FIG. 5B shows waste wane edges 44 dropping after being removed by saw blades 54 with horizontal carriage 90 beginning to move to the left. In FIG. 5C workpiece clamping devices 36 are raised to a release position to release board 20 from sawing table 28. Board 20 is ejected from support arms 70 of the adjustable width sawing table 28 by stop pin 92 as the new rough workpiece 18 is moved into position onto sawing table 28. Support arms 70 of sawing table 28 are configured to provide gaps 35 between each pair of support arms, see FIGS. 14-14B, to permit pin 92 and horizontal carriage 92 to pass therebetween during this ejection action. Ducking pincher 89, see FIG. 5C, moves a new rough workpiece 18 into position onto support arms 70 during this ejection action.

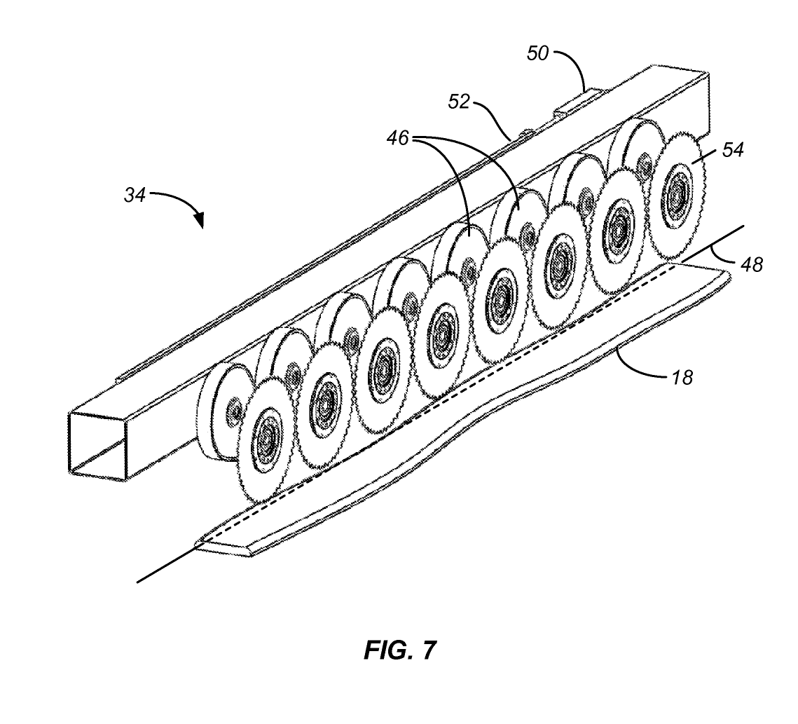

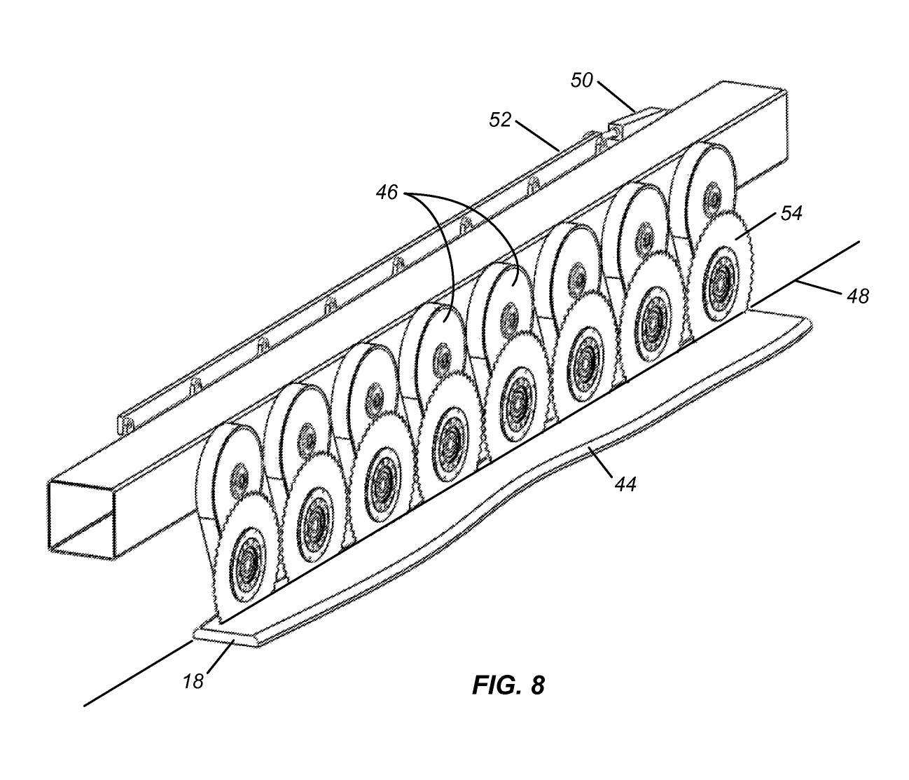

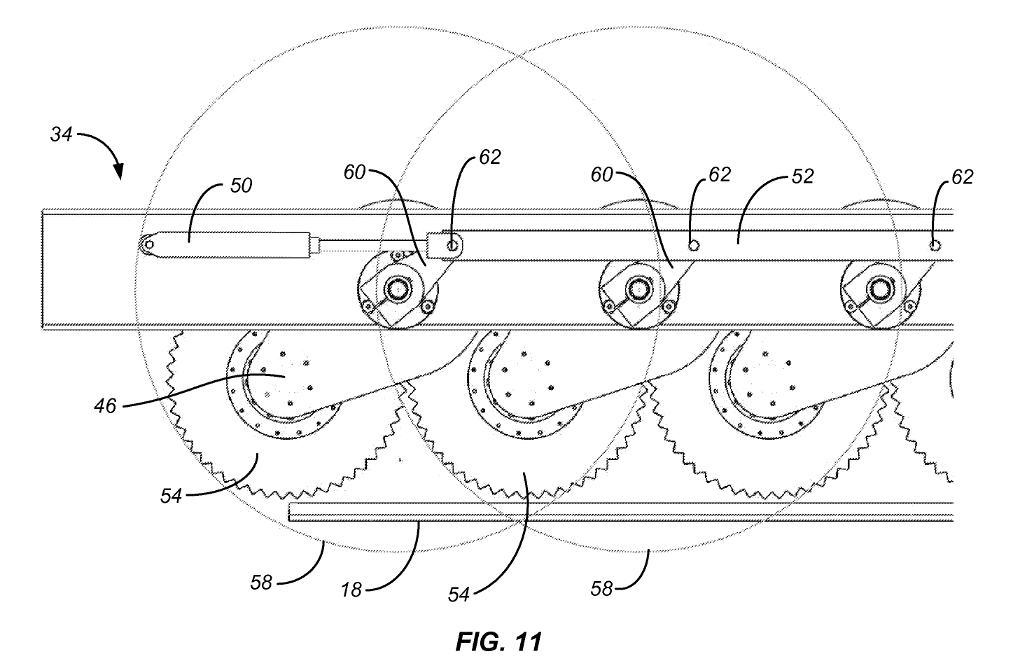

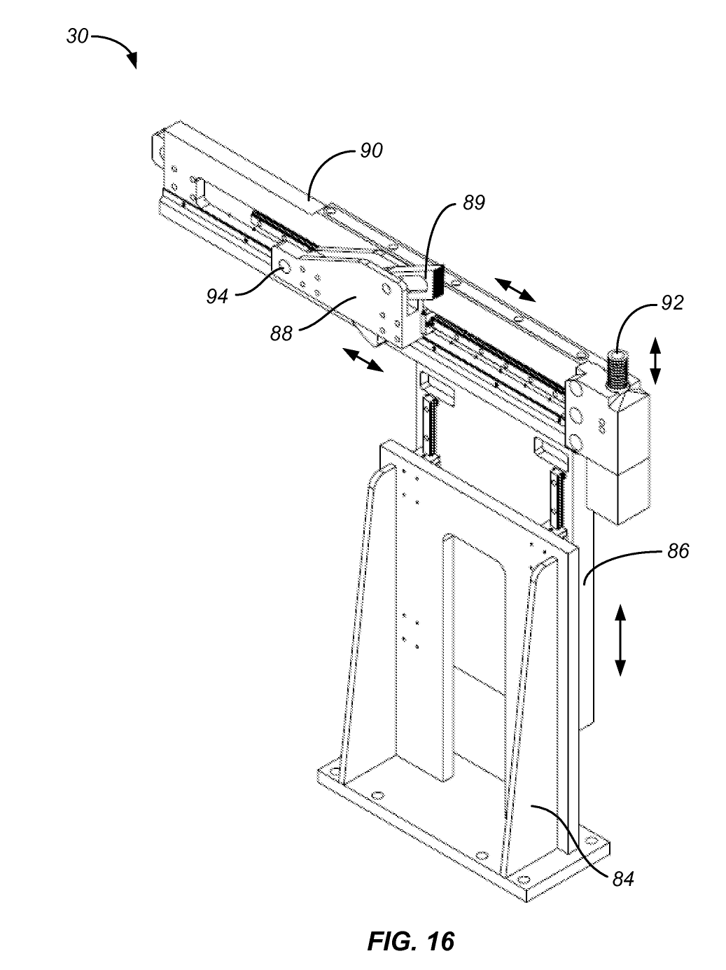

FIG. 5D illustrates cut board 20 dropping where it will be directed onto outfeed conveyor 22 by diverter tipple 32 shown in FIG. 5. FIG. 5D also shows a workpiece 18 positioned over sawing table 28. FIG. 5E shows movement of clamping devices 36 downwardly to a clamp position secure workpiece 18 to sawing table 28, the retraction of stop pin 92 and the downward movement of vertical carriage 86 and horizontal carriage 90 therewith. Once the stop pin 92 and horizontal carriage 90 have been lowered, saws 54 begin sawing workpiece 18, discussed below with reference to FIGS. 7-11. FIG. 5F shows waste wane edges 44 dropping and horizontal carriage 90 moved to the right. Workpiece 18 in FIG. 5F is the next workpiece that the lug chain 14, not shown, has brought into position. The workpiece positioner 30 will rise up and clamp this workpiece 18 and take it over to the sawing table 28. FIGS. 5G and 5H show vertical carriage 86 and stop pin 92 moved upwardly with a new workpiece 18 positioned between stop pin 92 and ducking pincher 89. Referring also to FIG. 16, each pincher carriage 88 of workpiece positioner 30 is coupled to a linear actuator, not shown, at a linear actuator connection point 94 and moves ducking pincher 89 towards air operated stop pin 92 clamping workpiece 18 between ducking pincher 89 and air operated stop pin 92. Ducking pincher 89 is pivoted downwardly by workpiece 18 being driven in the direction of feed path 15 by advancing lugs 24 of infeed conveyor 12. Vertical carriage 86 lifts horizontal carriage 90 along with workpiece 18 slightly above, typically ¼″ (6.4 mm), the transfer chain 14. The next cycling procedure can then be started.

Horizontal carriage 90 advances workpiece 18 towards adjustable width sawing table 28 along feed direction 15. Horizontal carriage 90 is stopped when workpiece 18 is positioned over adjustable sawing table 28 in the optimum sawing position as determined by the control system. Vertical carriage 86 of workpiece positioner 30 lowers workpiece 18 down onto adjustable sawing table 28 while each of the six workpiece clamping devices 36 engages workpiece 18 firmly clamping workpiece 18 to adjustable sawing table 28. After workpiece 18 is firmly clamped to adjustable sawing table 28, stop pin 92 retracts and vertical carriage 86 lowers horizontal carriage 90 down below workpiece 18 and horizontal carriage 90 retracts back in a direction reverse of feed direction 15 back to a home position beneath the next advancing workpiece 18. Vertical carriage 86 lifts horizontal carriage 90 along with stop pin 92 and ducking pincher 89 to engage the next advancing workpiece 18 starting the positioning cycle all over again. See FIGS. 5B-5F.

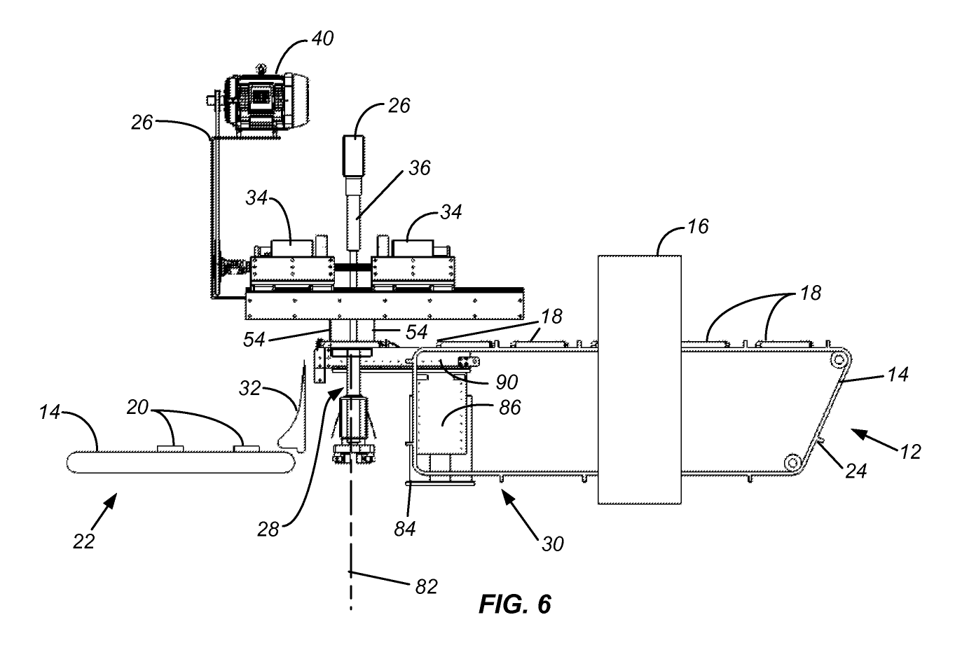

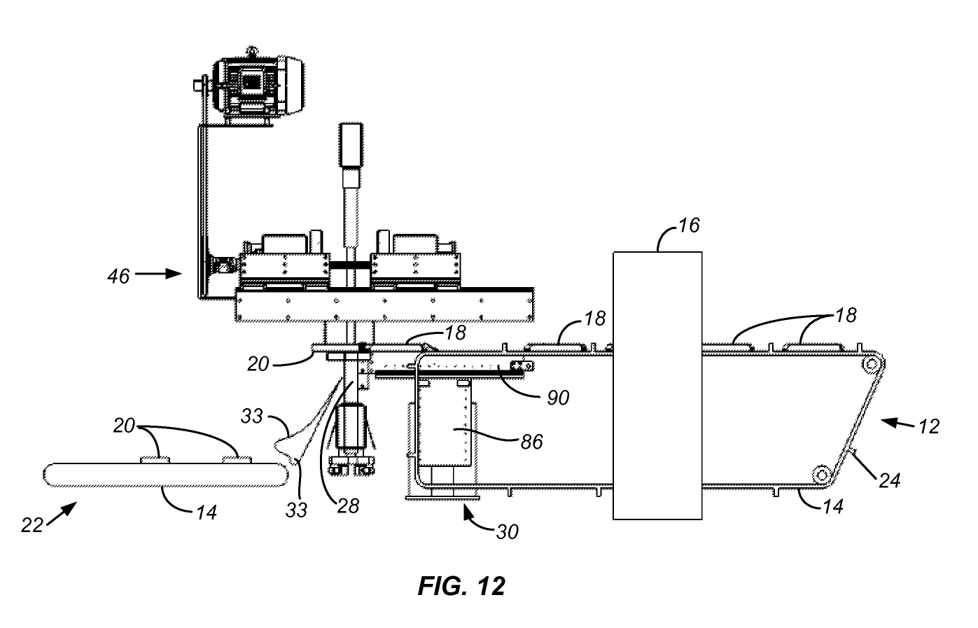

Referring now to FIGS. 6-12, with workpiece 18 firmly clamped by workpiece clamping device 36 to adjustable sawing table 28, an overhead saw array 34 of swing saw assemblies 46 is poised over workpiece 18 with saw blades 54 of swing saw assemblies 46 aligned with optimum cut line 48. Optimum cut line 48 is typically generally parallel to the length of workpiece 18. Swing saw actuator 50 is connected to bell crank arm 60 and swing saw linkage 52 through bell crank pin 62. Additional bell crank pins 62 connect swing saw linkage 52 to the bell crank arms 60 of the other swing saw assemblies 46 in the overhead saw array 34. Swing saw actuator 50, through bell crank pin 62 and linkage 52, drives and causes swing saw assemblies 46 to rotate about saw swing axis 56 causing the saw blades 54 to follow along the saw swing cutting radius 58 and cut workpiece 18 along optimum cut line 48. The waste wane edges 44 (FIG. 4) fall clear of adjustable sawing table 28. Diverter tipple 32 (FIG. 12) rotating about diverter tipple pivot axis 33 assumes the discharge position while horizontal carriage 90 of workpiece positioner 30 carries workpiece 18 clamped between stop pin 92 and ducking pincher 89 in a direction along feed path 15 where the leading edge of stop pin 92 engages and pushes cut board 20 off of adjustable sawing table 28 and causing cut board 20 to slide down diverter tipple 32 landing on outfeed conveyor 22.

In the case where it is desirable to cut the workpiece 18 into a plurality of cut boards 20, the initial cutting sequence is the same as described above with the exception that after the swing saw assemblies 46 of overhead saw array 34 swing down and through the workpiece 18, one or both rows of overhead saw arrays 34 will reposition along one or two paths perpendicular to the cut face of the workpiece 18 to optimum cut lines as directed by the control system. Once the sawing arrays 34 are in position, swing saw assemblies 46 will swing back down and through workpiece 18 typically resulting in 2 or 3 cut boards. In some cases, the optimum cut line 48 for the additional cut does not overlie the support arms 70, see FIG. 14, of the sawing table 28 so that no repositioning of workpiece 18 or movement of support arms of 70 is needed for the additional cut. In other cases it may be necessary to reposition workpiece 18 and/or to reposition support arms 70 to the orientation of, for example, FIG. 14A to make the additional cut.

FIGS. 13 and 13A illustrate a swing saw assembly 46 including a saw drive shaft 64 shown connected to and driving a cogged pulley 96 which is connected to a cogged pulley 98 by a cogged belt 100. The saw blade 54 is secured to and rotated by cogged pulley 98. Pulleys 96, 98 are housed within and carried by a housing 102 which, along with pivot housing 68, is supported by drive shaft 64 using appropriate bearings to permit drive shaft 64 to rotate freely relative to bell crank arm 60, pivot housing 68 and housing 102. This permits a drive shaft 64 to rotate and cause saw blade 54 to spin around its axis 66 and also allows swing saw assembly 46 to move about the swing axis 56 through the movement of bell crank arm 60. Drive shaft 64 is a splined drive shaft to allow saw blades 54 to be positioned at different axial positions along the drive shaft. In this example, both rows of saw blades 54 can be positioned at different axial positions. In some examples, it may be desired to have one row of saw blades 54 to be at a fixed position.

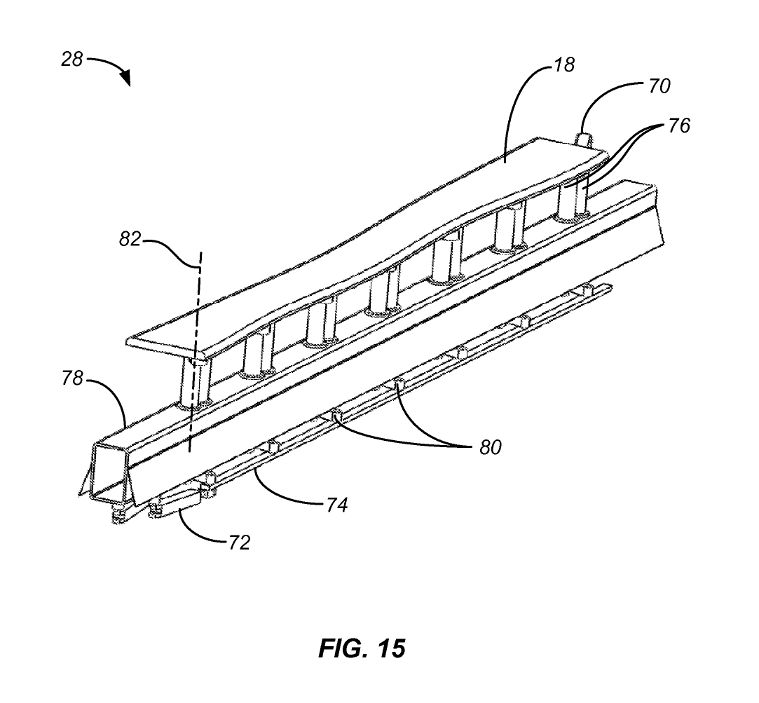

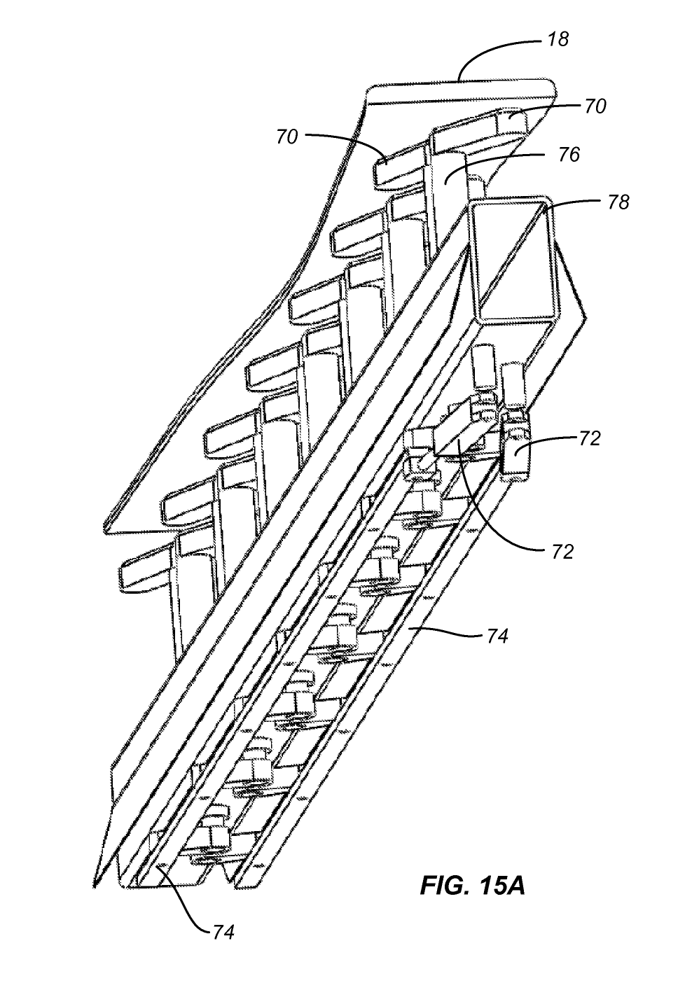

When supporting a rough workpiece 18, it is desirable that the workpiece be supported close to but not at the optimum cut line 48. Further, it is desirable that the sawing table 28 not hinder the ejection of the cut board 20. The design of adjustable width sawing table 28 accommodates both of these concerns. Support arms 70, see, see FIGS. 14-15A, are supported by rotatable pivot the tubes 76 and have upper surfaces defining a support table surface. The support table surface has a width oriented perpendicular to the length of support tube 78. Support arms 70 can be positioned at various orientations by the rotation of pivot tube 76 to allow the outer ends of support arms 70 to be positioned close to optimum cut lines 48 for optimum support of workpiece 18 during the cutting operation. Pivot tubes 76 are connected to the inner ends of support arm bell cranks 80. The outer ends of support arm bell cranks 80 are connected to linkage bars 74 on each side of support tube 78. A support arm pivot actuator 72 is used to move each linkage bar 74 thus causing the bell crank 80 to rotate their associated pivot tube 76 about their associated pivot axis 82. The width of the support table surface is a minimum width in the example of FIG. 14A, an intermediate width in the example of FIG. 14, and a maximum width in the example of FIG. 14B. Also, gaps 35 between each pair of support arms 70 are sufficiently wide that even when the support arms are aligned, such as in FIG. 14A, the gap is wide enough as to permit stop pin 92 and horizontal carriage 90 to pass therebetween. In this example, support tubes 76 are arranged as closely as-spaced pairs of support tubes; other arrangements are also possible. Also, in some examples, support arms 70 may be configured so that in some orientations any gap between the support arms is not sufficient to permit stop pin 92 to pass therebetween; in such an example sport arms 70 may be reoriented after the cut is made to provide a sufficient gap for the passage of stop pin 92 and horizontal carriage 90.

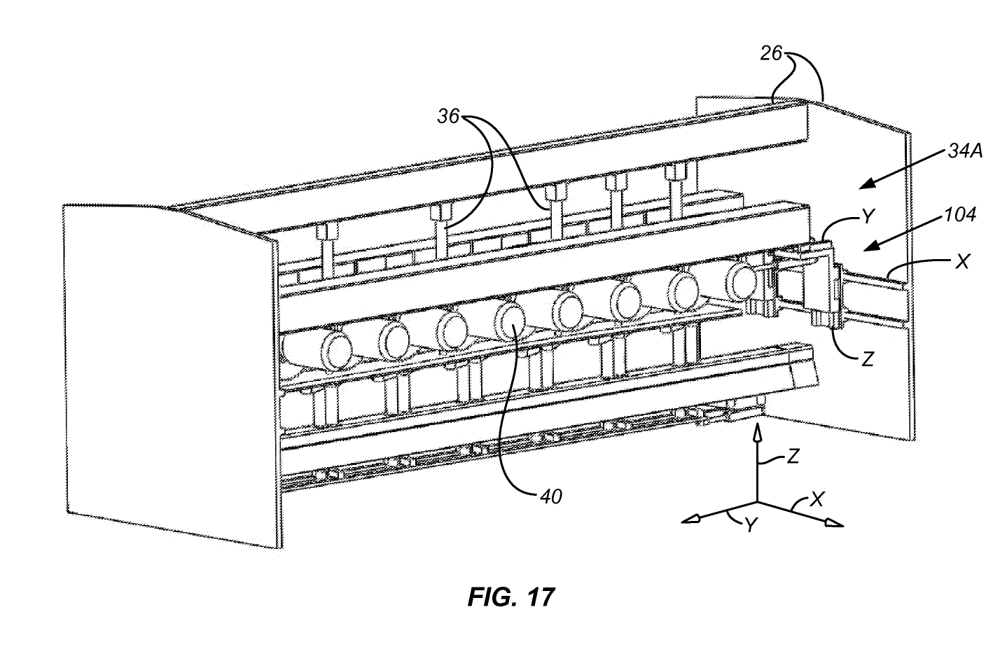

FIGS. 17 to 21 illustrate another example of an overhead saw array 34A shown in conjunction with adjustable width sawing table 28, frame 26 and workpiece clamping device 36 with like reference numerals referring to like elements. Instead of swing saw assemblies 46, overhead saw assemblies 34A include drop saw assemblies 46A having saw blades 54 which move along rectilinear paths instead of along circular paths as do the saw blades 54 of swing saw assembly 46. In this example, two rows of saws 54 are used. Each saw 54 is driven, in this example, directly by a drive motor 40. Each row of drive motors 40 is supported by a frame element 26A. Each end of each frame element 26A is supported by an XYZ slide way assembly 104 permitting each overhead saw array 34A move in an X direction, that is parallel to feed path 15, in a Y direction, that is parallel to optimum cutline 48, and vertically in a Z direction. The XYZ slide way assembly 104 can be made from conventional, typically off the shelf bearings and tracks. Movement of slide way assembly 104 can be accomplished with conventional electric linear actuators or hydraulic actuators.

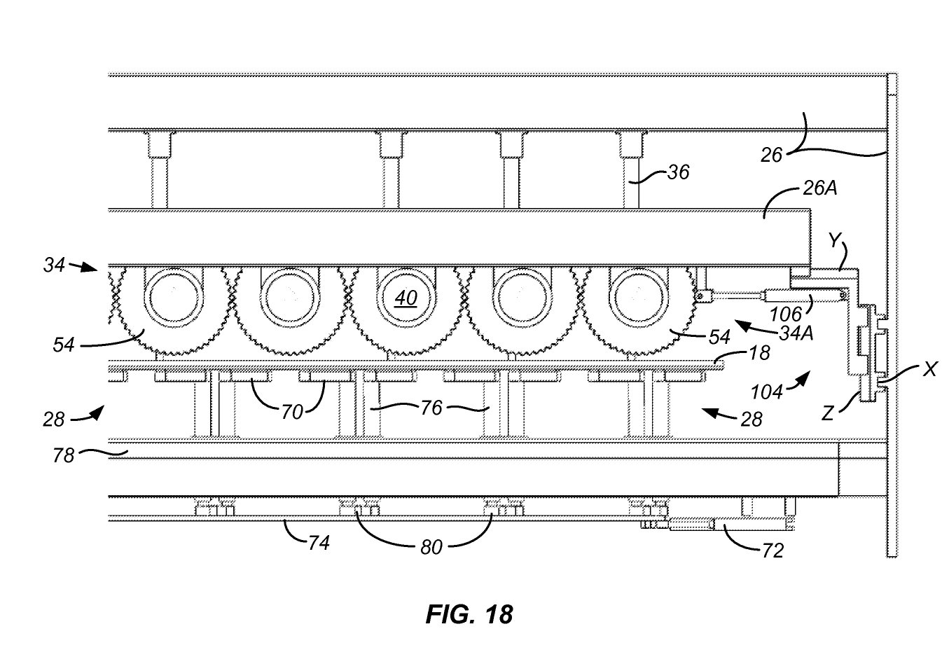

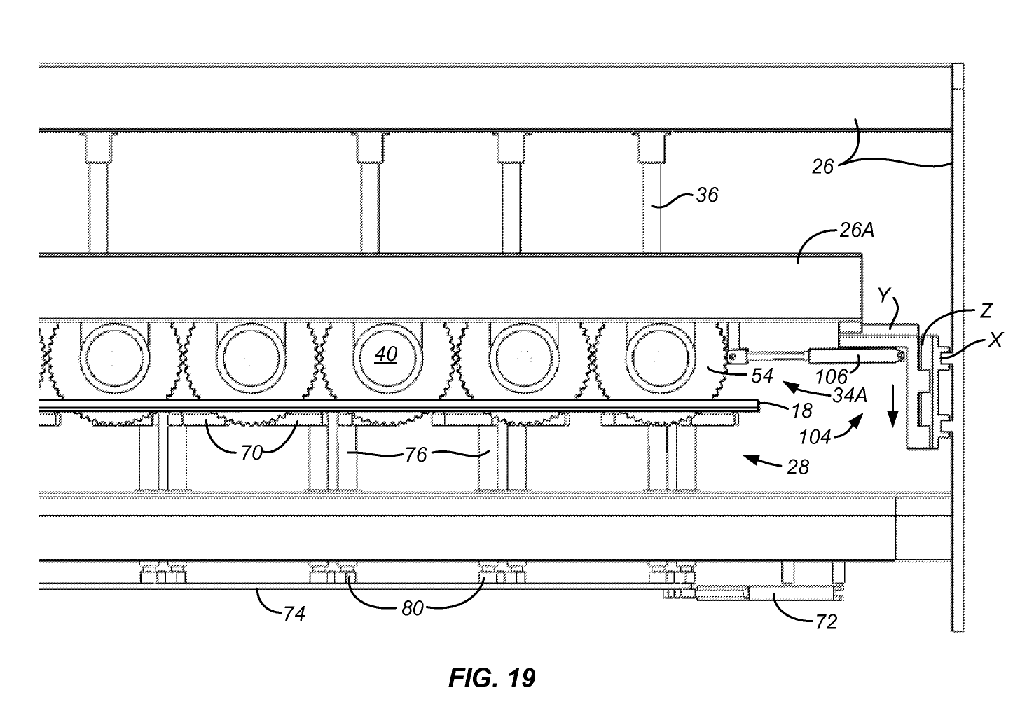

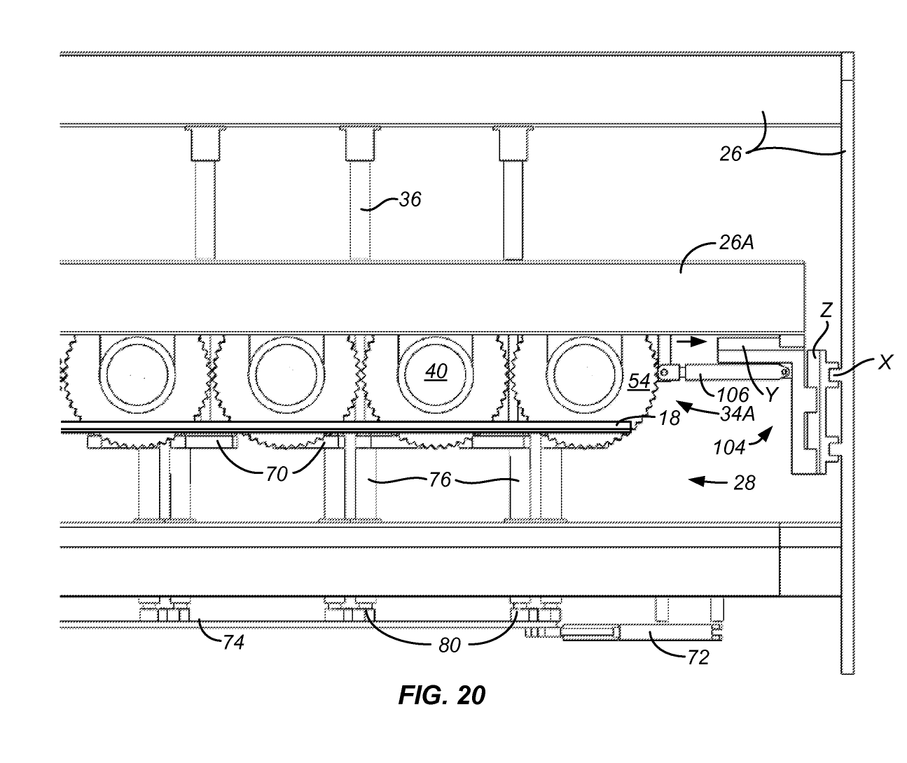

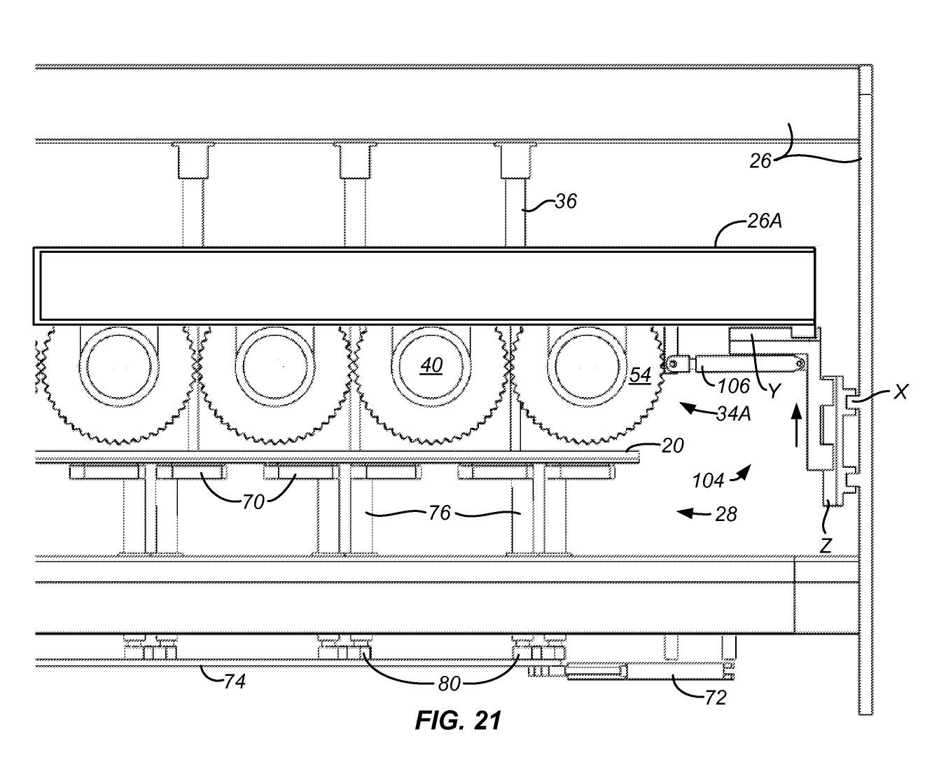

FIGS. 18-21 illustrate the sequence of movements by XYZ slide way assembly 104. Starting at the position of FIG. 18, assembly 104 first causes both overhead saw assemblies 34A to move vertically downwardly along the Z slide way creating a plunge cut into workpiece 18 as illustrated in FIG. 19. Actuator 106 of XYZ slide way assembly 104 then retracts, as seen by comparing FIGS. 19 and 20, causing saw assemblies 34A to move to the right along the Y slide way to finish the cut along cut line 48. Saw arrays 34A are then raised with movement along Z slide way to the position of FIG. 21. At this point board 20 can be ejected and replaced with a new workpiece 18 as discussed with reference to FIGS. 5B-5E. Alternatively, one or more additional cuts can be made to board 20 before the cut board is ejected.

The example of FIGS. 17-21 is expected to have a cutting cycle of about 0.5 seconds as opposed to the cutting cycle of about 0.3 seconds for the first example. Although this cutting cycle is longer than the cutting cycle of the first example, it is still a substantial improvement over the typical cutting cycle of conventional equipment. The example of FIG. 17-21 may be preferred over the first described example of FIGS. 1-16 because of its simplicity, ruggedness, expected lower cost to manufacture, and the significant improvement in cutting cycle time over conventional equipment. For example, instead of the saw drive mechanism 42, including multiple pulleys and belts, of the first example of FIGS. 1-13A, saw blades 54 are connected directly to the output shaft 39, see FIG. 5, of drive motors 40, a much simpler design.

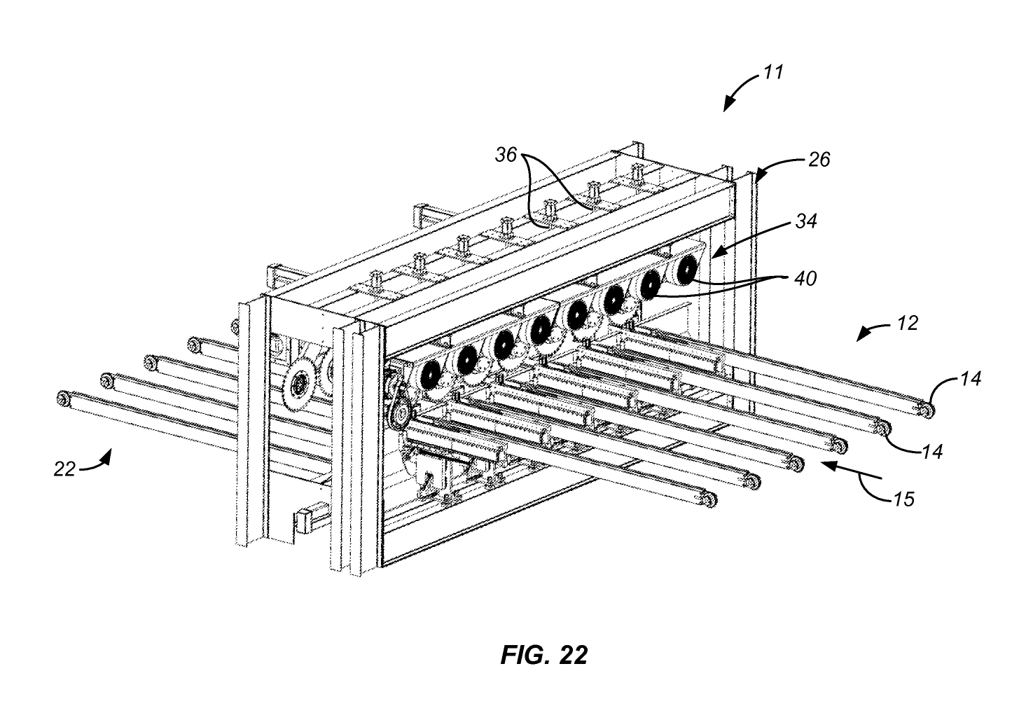

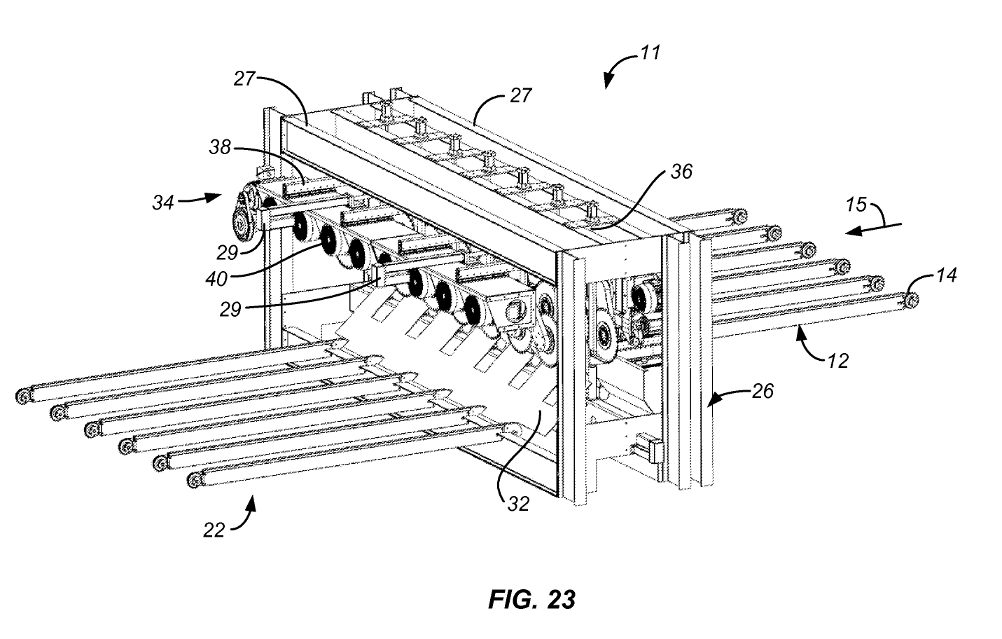

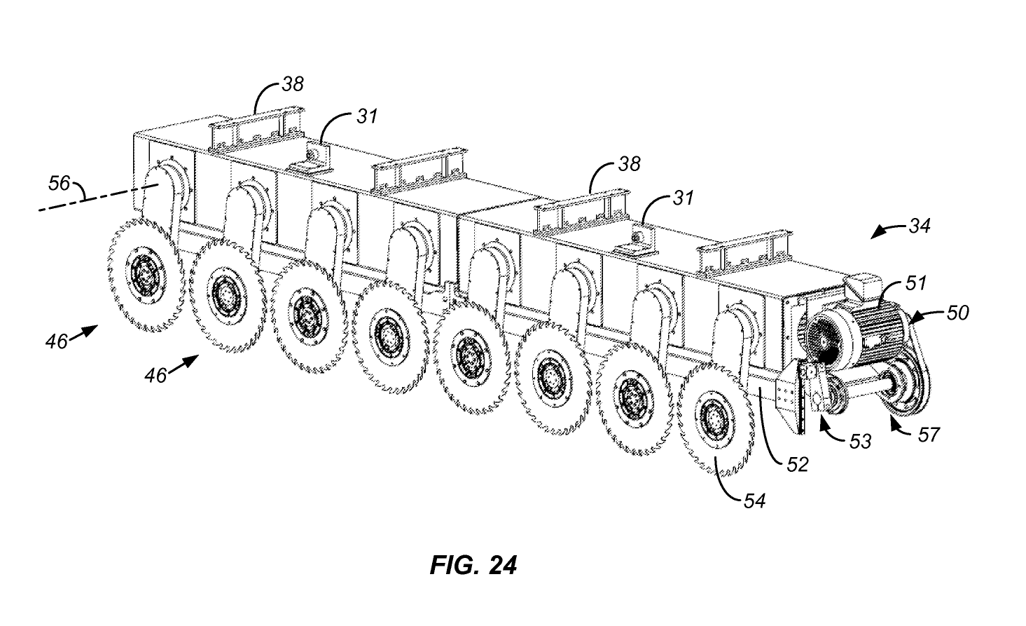

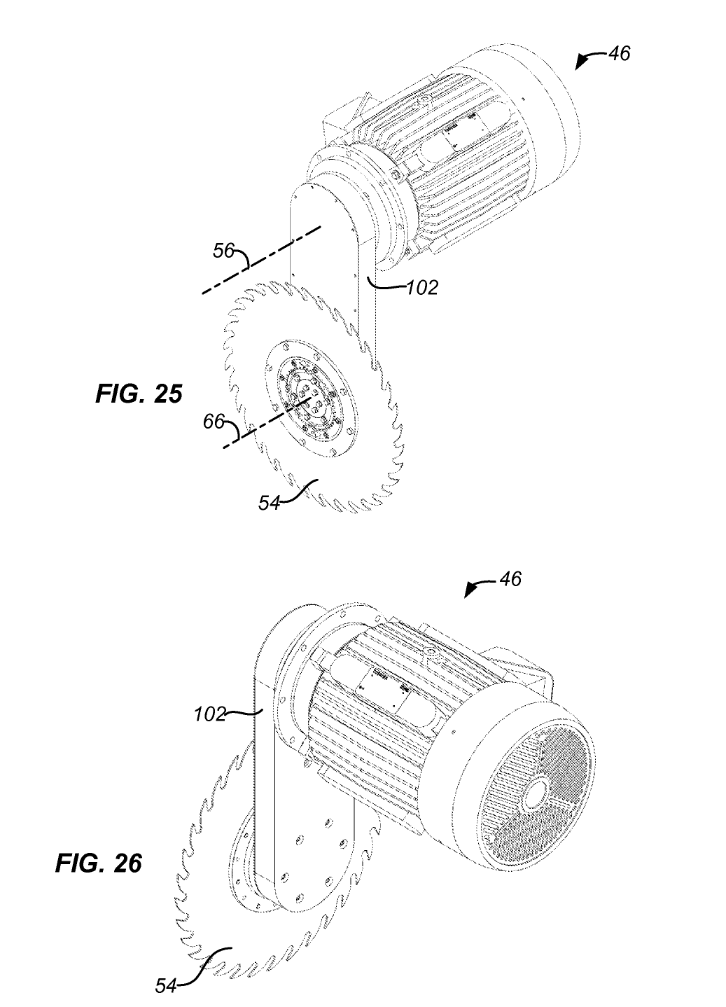

FIGS. 22-27 show a third example of a sawing system 11 made according to the invention with like reference numerals referring to like elements. The third example is similar to the swing saw type of sawing system of FIGS. 1-16. FIGS. 22 and 23 are isometric views of the infeed side and of the outfeed side of the third example of sawing system 11 were the primary differences relates to the construction of overhead saw array 34. Each overhead saw array 34 is mounted to and suspended by a set of four saw array slide ways 38 which slideably engage an overhead portion 27 of frame 26. Each overhead saw array 34 is positioned along feed path 15 by a pair of linear positioners 29. Each linear positioner 29 is supported by frame 26 and is connected to overhead saw array 34 by a connection element 31 as seen in FIG. 24.

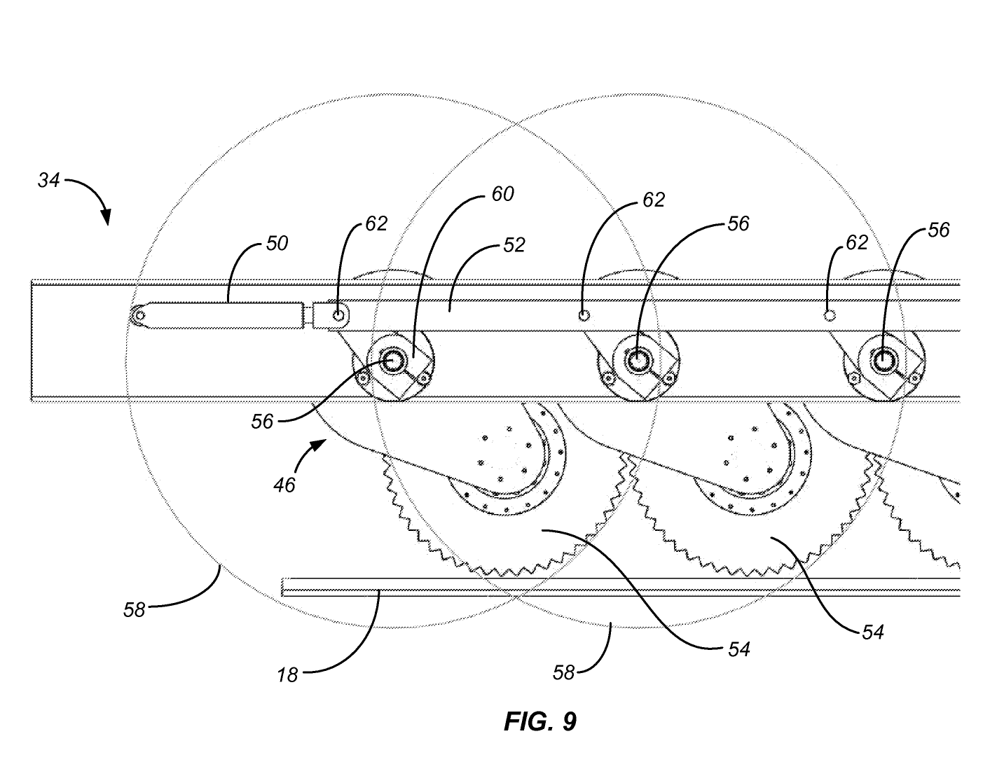

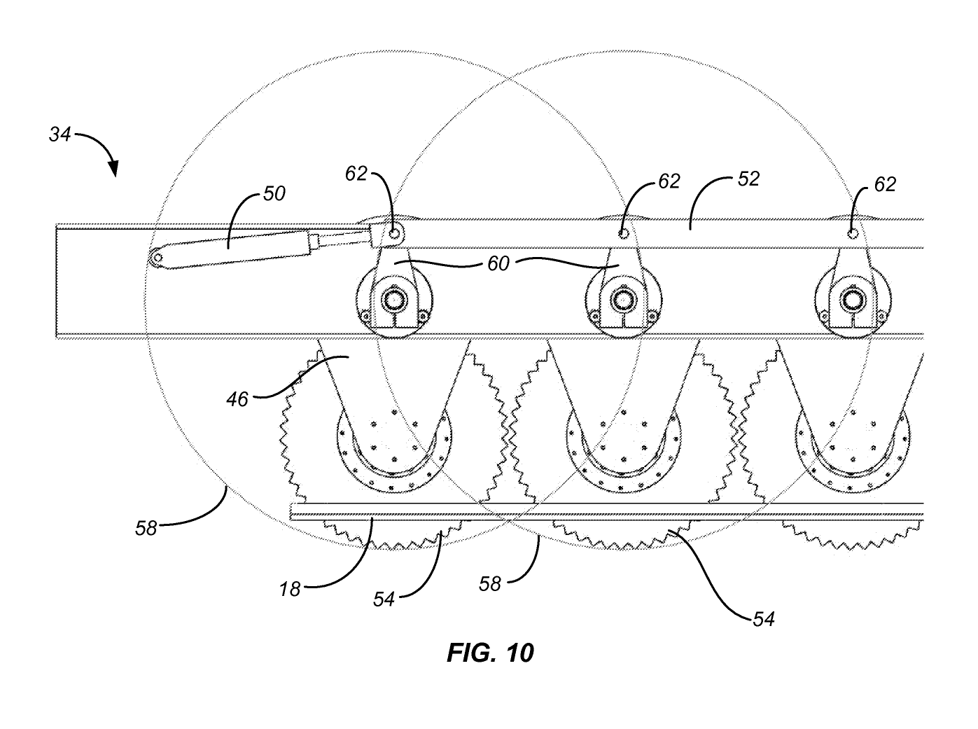

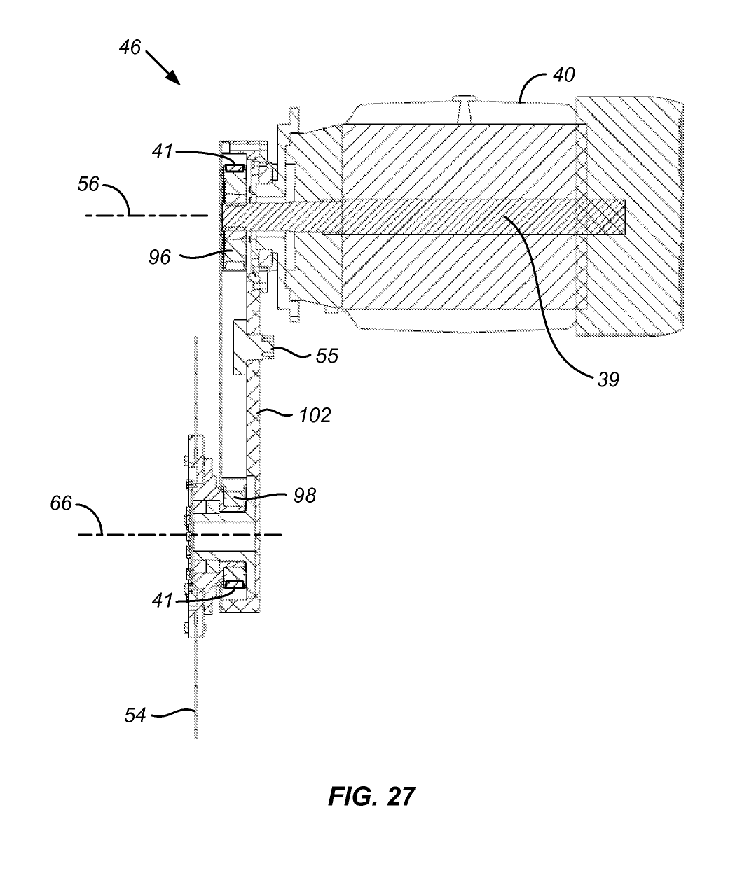

FIG. 24 is an isometric view showing another difference from the overhead saw array 34 shown in FIG. 7-11. Instead of the linear actuator type of saw swing actuator 50 of FIGS. 9-11, saw swing actuator 50 of FIG. 24 uses a motor 51 to drive a scotch yoke type of actuator 53 through a drive train 57 causing the reciprocal movement of swing saw linkage 52. Swing saw linkage 52 is connected to the housing 102 of each swing saw assembly 46 by a pivot connection 55 shown in FIG. 27. Comparing FIG. 27 to FIGS. 12-13A, saw assembly 46 of FIG. 27 is seen to be a much simpler design than that of FIGS. 12-13A. However, the movement of the saw blades 54 of the swing saw assemblies 46 of FIGS. 22-27 are substantially the same as discussed above with regard to FIGS. 7-11.

The third example of FIG. 22-27 may be preferred over the first described example because of its simplicity, ruggedness and expected lower cost to manufacture. For example, instead of the saw drive mechanism 42, including multiple pulleys and belts, of the first example of FIGS. 1-13A, saw blades 54 of the third example are connected to the output shaft 39 of drive motors 40 by a relatively simple drive train 57.

The above described examples of overhead saw arrays 34, 34A have saw blades 54 which move along circular or rectilinear paths. Other paths may also be traversed by saw blades 54, for example non-circular curved paths, straight segment portions not at 90° to one another or a combination of curved and straight path segments. Saw blades 54, regardless of the particular path shape, are movable along two-dimensional paths during use.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

List of Reference Numbers

```
  10. Automatic workpiece edging and ripping system
  11. Sawing system
  12. Infeed conveyor
  14. Individual chains
  15. Feed path
  16. Optical workpiece interrogator
  18. Workpiece
  20. Cut boards
  22. Outfeed conveyor
  24. Advancing lugs
  26. Frame
  26A. Frame element
  27. Overhead portion of frame 26
  28. Adjustable width sawing table
  29. Linear positioner
  30. Workpiece positioner
  31. Connection element
  32. Diverter tipple
  33. Diverter tipple pivot axis
  34. Overhead saw array
  35. Gaps
  36. Workpiece clamping device
  38. Saw array slide ways
  39. Output shaft
  40. Saw drive motor
  41. Drive belt
  42. Saw drive mechanism
  43. Drive pulley
  44. Waste wane edges
  46. Swing saw assembly
  46A. Drop saw assembly
  48. Optimum cut line
  50. Saw swing actuator
  51. Motor
  52. Saw swing linkage
  53. Scotch yoke type of actuator
  54. Saw blade
  55. Pivot connection
  56. Saw swing axis
  57. Drive train
  58. Saw swing cutting radius
  60. Bell crank arm
  62. Bell crank pin
  64. Saw drive shaft
  66. Saw rotation axis
  68. Pivot Housing
  70. Support arm
  72. Support arm pivot actuator
  74. Linkage bar
  76, 78. Pivot, support tubes
  80. Support arm bell crank
  82. Support arm pivot axis
  84. Support base
  86. Vertical carriage
  88. Pincher carriage
  89. Ducking pincher
  90. Horizontal carriage
  92. Stop pin
  94. Linear actuator connection point
  96, 98. Cogged drive, driven pulleys
100. Cogged belt
102. Housing
104. XYZ Slide Way Assembly
106. Actuator
```

What is claimed is:

1. A sawing apparatus, usable as part of a wood products sawing system, comprising:
a frame;
a sawing table on which a workpiece can be supported, the sawing table having a table length axis and the workpiece having a workpiece length and a cut line generally parallel to the table length axis;
a workpiece clamping element, supported by the frame, arranged over the sawing table and placeable in a clamp position, to secure the workpiece against the sawing table with the cut line oriented parallel to the table length axis, and a release position, to release the workpiece from the sawing table; and
an overhead saw array, supported by the frame, comprising:
a saw driver;
a row of at least three saw assemblies, each saw assembly comprising a saw blade rotatable around a saw rotation axis passing through the center of the saw blade, the saw rotation axes being parallel to one another;
a saw drive mechanism rotatably connecting the saw driver to the saw blades so to drive the saw blades around their saw rotation axes; and
means for simultaneously moving the saw blades along two-dimensional paths, the paths being aligned and defining a plane oriented perpendicular to the saw rotation axes;
whereby the workpiece can be severed along the cut line by movement of the saw blades along the paths.

2. The sawing apparatus according to claim 1 wherein the workpiece clamping element comprises a plurality of vertically extending clamping members.

3. The sawing apparatus according to claim 1 further comprising a plurality of parallel rows of said saw assemblies.

4. The sawing apparatus according to claim 1 wherein the saw driver comprises a plurality of saw drive motors, each saw drive motor comprising an output shaft.

5. The sawing apparatus according to claim 4 wherein the saw drive mechanism comprises the following for each drive motor: a first drive belt coupling the output shaft to a first pulley, the first pulley drivingly connected to a saw drive shaft, the saw drive shaft connected to a second pulley, a second drive belt coupling the second pulley to a third pulley, at least one saw blade connected to and driven by the third pulley.

6. The sawing apparatus according to claim 4 wherein:
the saw drive mechanism comprises the following for each drive motor: a saw drive shaft drivenly connected to the output shaft, the saw drive shaft drivingly connected to the saw blade by a drivetrain, the drivetrain comprising a saw blade support pivotally mounted to the frame; and
the simultaneously moving means comprises a swing saw actuator coupled to the saw blade support for movement of the saw blade support from a first position with the saw blade at a first position along the two-dimensional path to a second position with the saw blade at a second position along the two-dimensional path.

7. The sawing apparatus according to claim 4 wherein the saw drive mechanism comprises said output shaft of the saw drive motor, the saw blade being driven directly by the output shaft.

8. The sawing apparatus according to claim 7 wherein:
the frame comprises a frame element;
the plurality of saw drive motors, the saw drive mechanism, and the saw assemblies being mounted to a supported by the frame element;
the simultaneously moving means comprises a slide way assembly supporting the frame element for movement of the plurality of saw drive motors, the saw drive mechanism, and the saw assemblies along a slide way path with the saw blades moving along the two-dimensional paths.

9. The sawing apparatus according to claim 8 wherein the slide way assembly comprises an XYZ slide way assembly and the slide way path is a rectilinear path so the two-dimensional paths are rectilinear paths having a generally vertical portions and a generally horizontal portion.

10. The sawing apparatus according to claim 1 wherein the sawing table comprises:
a width measured perpendicular to the table length axis; and
a variable width workpiece support surface.

11. A method for sawing a workpiece along a cut line comprising:
temporarily securing a workpiece on a sawing table with a cut line oriented at a desired orientation;
positioning a row of at least three saw assemblies over the workpiece, each saw assembly comprising a saw blade rotatable around a saw rotation axis passing through the center of the saw blade with the saw rotation axes being parallel to one another;
rotating the saw blades around their saw rotation axes;
severing the workpiece along the cut line by moving the rotating saw blades along two-dimensional paths passing through the cut line, the paths being aligned and defining a plane oriented perpendicular to the saw rotation axes; and
releasing the severed workpiece from the sawing table.

12. The sawing method according to claim 11 wherein the temporary securing step comprises directing a plurality of vertically extending clamping members against the workpiece.

13. The sawing method according to claim 11 further comprising positioning a plurality of parallel rows of said saw assemblies over the workpiece.

14. The sawing method according to claim 11 wherein each saw blade is rotated by a separate saw drive motor.

15. The sawing method according to claim 11 wherein the saw blades rotating step comprises drivingly coupling the output shaft of a saw drive motor to an associated saw blade through a drivetrain comprising at least one pulley and at least one drive belt, the output shaft being laterally offset from the associated saw rotation axis.

16. The sawing method according to claim 11 wherein the workpiece severing step comprises moving the saw blade along a curved path so that the two-dimensional path is a curved two-dimensional path.

17. The sawing method according to claim 11 wherein the workpiece severing step comprises moving the saw blade along a circular path so that the two-dimensional path is a circular two-dimensional path.

18. The sawing method according to claim 11 wherein the saw blades rotating step comprises connecting the output shaft of a saw drive motor to an associated saw blade, the output shaft having an output shaft axis generally collinear with the associated saw rotation axis.

19. The sawing method according to claim 11 wherein the workpiece severing step comprises moving the saw blade along a path comprising at least one straight segment so that the two-dimensional path is a path comprising at least one straight segment.

20. The sawing method according to claim 11 wherein the workpiece severing step comprises moving the saw blade along a rectilinear path comprising straight segments so that the two-dimensional path is a rectilinear two-dimensional path comprising straight segments.

21. A sawing table, usable as part of a wood products sawing apparatus, comprising:
a frame member having a length;
a table assembly comprising:
a driving assembly; and
a row of support arm assemblies mounted to the frame member and coupled to the driving assembly for movement to at least first and second positions;
each support arm assembly comprising a support arm positioned above the frame member;
the support arms having upper surfaces defining a support table surface, the support table surface having a width oriented perpendicular to the length of the frame member; and
the width of the support table being shorter when the support arm assemblies are in the first position than in the second position.

22. The sawing table according to claim 21 wherein the support arms define gaps therebetween when in the first and second positions.

23. The sawing table according to claim 21 wherein the support arm assemblies comprise elongate pivot members mounted to the frame member for pivotal movement about support arm pivot axes, the support arms at upper ends of the pivot members.

24. The sawing table according to claim 23 wherein the driving assembly comprises:
a support arm bell crank extending from each of the elongate pivot members;
a linkage member connecting a plurality of the support arm bell cranks to one another; and
an actuator operatively connecting the linkage member to the frame member to place the linkage member at chosen positions relative to the frame member thereby causing the support arm bell cranks to rotate the elongate pivot members and place the support arm assemblies in the first and second positions.

25. The sawing table according to claim 23 comprising pairs of closely spaced elongate pivot members.

26. The sawing table according to claim 25 wherein the driving assembly comprises:
first and second sets of support arm bell cranks extending in different directions from of the elongate pivot members;
a first linkage member connecting the first set of support arm bell cranks to one another, and a second linkage member connecting the second set of support arms bell cranks to one another; and
at least one actuator operatively connecting the linkage members to the frame member to place the linkage members at chosen positions relative to the frame member thereby causing the support arm bell cranks to rotate the elongate pivot members and place the support arm assemblies in the first and second positions.
